(19) United States
(12) Patent Application Publication
(10) Pub. No.: US 2026/0350610 A1
(43) Pub. Date: Nov. 5, 2026

(54) SYSTEMS AND METHODS FOR AN INTELLIGENT ROUTING ENGINE FOR AN OPT-IN COLLABORATIVE DIGITAL LEDGER NETWORK

(71) Applicant: BANK OF AMERICA CORPORATION, Charlotte, NC (US)

(72) Inventors: Sai Krishna Reddy Vutakanti, Hyderabad (IN); Antony Robert Raj, Kaniyakumari (IN)

(73) Assignee: BANK OF AMERICA CORPORATION, Charlotte, NC (US)

(21) Appl. No.: 19/198,543

(22) Filed: May 5, 2025

(51) Int. Cl. G06Q 20/40; G06F 16/901

(52) U.S. Cl. CPC G06Q 20/401; G06F 16/9024; G06Q 2220/10

(57) ABSTRACT

Systems, computer program products, and methods are described herein for an intelligent routing engine for an opt-in collaborative digital ledger network. Embodiments of the present disclosure are configured to identify an initiated transaction on a digital ledger network, retrieve one or more graphs from a graph database associated with the initiated transaction, analyze the one or more graphs associated with the initiated transaction, identify, via the analysis of the one or more graphs, one or more transaction related benefits associated with one or more similar transactions, generate, using the one or more transaction related benefits, a recommendation for a user associated with the initiated transaction, transmit the recommendation to a user device associated with the user, receive, via the network interface and from the user device, approval of the recommendation, and update, based on the approval of the recommendation, the initiated transaction.

### FIELD OF THE INVENTION

The present invention embraces a system for an intelligent routing engine for an opt-in collaborative digital ledger network.

### BACKGROUND

Presently, in today's environment, determining what combination of resource-exchange devices, entity offers, and the like for a best outcome of a transaction based on a user's needs and identifying potential threats associated with such transactions is a complex task. Therefore, there is a need for systems that may intelligently analyze transaction data, recommend suitable resource-exchange devices, entity offers, and the like, and identify high-threat transactions in real time.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for an intelligent routing engine for an opt-in collaborative digital ledger network may include a network interface configured to communicate via a communication network, at least one non-transitory storage device including computer program code stored thereon, and at least one processing device operably coupled to the network interface, and the at least one non-transitory storage device. In some embodiments, the computer program code may include computer instructions configured to cause the processing device to identify an initiated transaction on a digital ledger network coupled across the communication network via the network interface, retrieve one or more graphs from a graph database associated with the initiated transaction, analyze the one or more graphs associated with the initiated transaction, identify, via the analysis of the one or more graphs, one or more transaction related benefits associated with one or more similar transactions, generate, using the one or more transaction related benefits, a recommendation for a user associated with the initiated transaction, transmit the recommendation to a user device associated with the user, receive, via the network interface and from the user device, approval of the recommendation, and update, based on the approval of the recommendation, the initiated transaction.

In some embodiments, the at least one non-transitory storage device may include computer-executable program code that, when executed by the at least one processing device, causes the at least one processing device to, when retrieving the one or more graphs, query a first subsection of the graph database associated with indexes associated with a plurality of graphs stored in a second subsection of the graph database, identify the one or more graphs in the graph database associated with the initiated transaction, and extract the one or more graphs from the second subsection of the graph database. Additionally, or alternatively, the at least one non-transitory storage device may include computer-executable program code that, when executed by the at least one processing device, causes the at least one processing device to, when identifying the one or more transaction related benefits, retrieve, from the digital ledger network, data associated with the user, identify, in the data associated with the user, one or more available resource-exchange devices of the user, and analyze the one or more available resource exchange devices to identify a resource-exchange device of the one or more available resource-exchange devices that yields the highest resource return if used in the initiated transaction.

In some embodiments, the at least one non-transitory storage device may include computer-executable program code that, when executed by the at least one processing device, causes the at least one processing device to, when identifying the one or more transaction related benefits, retrieve, from the digital ledger network, data associated with a resource associated with the initiated transaction, identify, in the data associated with the resource, a plurality of available entity offers associated with the resource, and analyze the plurality of available entity offers to identify a first entity offer of the plurality of available entity offers that yields the lowest loss of resources of the user. Further, the recommendation for the user may include the first entity offer and the identified resource exchange device. Additionally, or alternatively, a second entity offer of the plurality of available entity offers may include an offer for the user to transfer a higher amount of resources than the first entity offer upon completion of the initiated transaction and to receive a portion of the transferred higher amount of resources back at a later date upon meeting one or more requirements, and the recommendation to the user may include a plurality of options including the first entity offer and the second entity offer.

In some embodiments, the at least one non-transitory storage device may include computer-executable program code that, when executed by the at least one processing device, causes the at least one processing device to, when analyzing the one or more graphs, identify one or more threats associated with the one or more similar transaction and generate the recommendation including a notification of the identified one or more threats. Additionally, or alternatively, data associated with the initiated transaction may be stored as a graph and one or more subgraphs of the graph in the graph database.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrate technical components of an exemplary distributed computing environment for intelligent graph data triggers and/or an intelligent routing engine for an opt-in collaborative digital ledger network, in accordance with an embodiment of the disclosure;

FIG. 2 illustrates an exemplary AI engine subsystem architecture, in accordance with an embodiment of the disclosure;

FIG. 3 illustrates an exemplary generative AI subsystem, in accordance with an embodiment of the disclosure;

FIGS. 4A-4B illustrate an exemplary distributed ledger technology (DLT) architecture, in accordance with an embodiment of the disclosure;

FIG. 5 illustrates a flowchart for intelligent graph data triggers and/or an intelligent routing engine for an opt-in collaborative digital ledger network, in accordance with an embodiment of the disclosure;

FIG. 6 illustrates another flowchart for intelligent graph data triggers and/or an intelligent routing engine for an opt-in collaborative digital ledger network, in accordance with an embodiment of the disclosure;

FIG. 7 illustrates a process flow for intelligent graph data triggers and/or an intelligent routing engine for an opt-in collaborative digital ledger network, in accordance with an embodiment of the disclosure;

FIG. 8 illustrates another process flow for intelligent graph data triggers and/or an intelligent routing engine for an opt-in collaborative digital ledger network, in accordance with an embodiment of the disclosure;

FIG. 9 illustrates another process flow for intelligent graph data triggers and/or an intelligent routing engine for an opt-in collaborative digital ledger network, in accordance with an embodiment of the disclosure;

FIG. 10 illustrates another process flow for intelligent graph data triggers and/or an intelligent routing engine for an opt-in collaborative digital ledger network, in accordance with an embodiment of the disclosure;

FIG. 11 illustrates another process flow for intelligent graph data triggers and/or an intelligent routing engine for an opt-in collaborative digital ledger network, in accordance with an embodiment of the disclosure;

FIG. 12 illustrates another process flow for intelligent graph data triggers and/or an intelligent routing engine for an opt-in collaborative digital ledger network, in accordance with an embodiment of the disclosure;

FIG. 13 illustrates another process flow for intelligent graph data triggers and/or an intelligent routing engine for an opt-in collaborative digital ledger network, in accordance with an embodiment of the disclosure;

FIG. 14 illustrates another process flow for intelligent graph data triggers and/or an intelligent routing engine for an opt-in collaborative digital ledger network, in accordance with an embodiment of the disclosure;

FIG. 15 illustrates another process flow for intelligent graph data triggers and/or an intelligent routing engine for an opt-in collaborative digital ledger network, in accordance with an embodiment of the disclosure; and

FIG. 16 illustrates another process flow for intelligent graph data triggers and/or an intelligent routing engine for an opt-in collaborative digital ledger network, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data. Additionally, as used herein, a “subentity” may refer to a smaller, distinct part or group that may be a part of a larger entity. Typically, subentities may operate under the broader entity but may have their own specific functions, responsibilities, and/or goals. Subentities may be typically organized to handle specific tasks or serve particular groups within the larger framework.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, and/or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, “authentication credentials” may be any information that can be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning of, for example, distal phalanges, intermediate phalanges, proximal phalanges, and/or the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, and/or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, and/or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and/or the like.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository-a storage location where one or more resources are organized, stored and retrieved electronically using a computing device.

As used herein, a “resource transfer,” “resource distribution,” or “resource allocation” may refer to any transaction, activities, and/or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer”, a “transaction”, a “transaction event”, or a “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and/or the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, “data element” may refer to a single unit of information and/or of data within a datafile, database, dataset, document, image, PDF, and/or the like. The data element may represent a specific value and/or piece of data that is stored and/or processed. In other words, a data element may represent any individual piece of data within a structured collection of information. For example, in a spreadsheet, a data element may be a value in a single cell. In a database, a data element may be a specific field in a record. In a CSV file, data elements may be separated by commas and may include values such as “Product Name,” “Price,” or “User Address.” In an image, a data element may be a single pixel of the image and/or a collection of pixels representing a section of the image. In a datafile, a data element may be described as a single unit or piece of information that is stored within the datafile. The data element may represent a specific attribute or value related to the datafile's overall purpose. Each data element may be structured to hold a particular type of information (e.g., a number, text, a date, code, and/or the like). These elements are the building blocks of the datafile, working together to form a complete set of information that can be processed, analyzed, or stored.

As used herein, the terms “random,” “probabilistic,” “stochastic,” and similar terms generally refer to processes or systems where outcomes or events may be influenced by chance, uncertainty, and/or a set of probabilistic rules. These processes may be described by mathematical models that represent uncertainty or variability in outcomes, typically involving random variables and/or distributions. In some contexts, random and probabilistic processes may be used to model phenomena such as interaction patterns, resource market fluctuations, resource values, and/or the behavior of entities and/or users. A stochastic system, for example, may be one where a future state may be determined not solely by past states but also by some inherent randomness. For purposes of the present disclosure, these terms may describe systems, processes, parameters, elements, and/or methods that may be analyzed, modeled, and/or simulated using statistical and computational methods to predict and/or understand behavior over time. In some embodiments described herein, these words may be used interchangeably with one another.

The present disclosure may include a system, computer program, and/or method for intelligent graph data triggers and/or an intelligent routing engine for an opt-in collaborative digital ledger network. Presently, in today's environment, determining what combination of resource-exchange devices, entity offers, and the like for a best outcome of a transaction based on a user's needs and identifying potential threats associated with such transactions is a complex task. Therefore, there is a need for systems that may intelligently analyze transaction data, recommend suitable resource-exchange devices, entity offers, and the like, and identify high-threat transactions in real time.

In some embodiments, a plurality of users and a plurality of entities (e.g., financial institutions, vendors, resource lenders, groups, companies, associations, and/or the like) may opt to be included and/or share data to a collaborative digital ledger network (e.g., a block chain consortium) for available parties. In such embodiments, a large number of activities (e.g., transactions) may occur between participants of the digital ledger network that may be related to one or more users and/or entities. Embodiments of the present disclosure may be configured to identify and capture said activities via an event listener that is configured to pass data related to the activities to a transaction history monitor. As activities are initiated and undergo different phases, adjustments, and/or updates throughout their respective lifecycles, data related to each activity is captured, passed to the transaction history monitor, and may be visualized in graphical form (e.g., using various graph visualization libraries such as Graph GL) with help from an intelligent graph data trigger that may be configured to trigger for each activity and/or update to an activity encountered. Each graph may have a plurality of sub graphs and may effectively extend to N graphs, where N is a positive integer greater than one. Additionally, or alternatively, each subgraph may include data of activities and/or may include a plurality of subgraphs. Further, if a transaction is deemed successful, then data related to that transaction is captured, indexed, and updated accordingly.

Embodiments of the present disclosure may be configured to query the graph database via a query language (e.g., GraphQL) to search and identify associated graphs to a present transaction. Additionally, or alternatively, the graph database may include a plurality of indexes that identify locations of specific graphs for efficient querying and retrieval of necessary data. In some embodiments, the digital ledger network may be configured to serve as a repository of graphs and/or subgraphs generated for transactions. Additionally, or alternatively, the graph database may be coupled to the digital ledger network via a network interface.

In some embodiments, any kind of high threat activity as deemed by specific parameters, constraints, guidelines, and/or the like (e.g., checklists of customer due diligence (CDD) and enhanced due diligence (EDD)) that indicate any suspicious matter reports (SMR) may be updated in the respective indexes.

Embodiments of the present disclosure may include an intelligent graph index framer coupled with AI (e.g., LLMs) via an AI application framework (e.g., LangChain) to generate and/or frame indexes for successful transactions, threatening activity, and/or the like. Additionally, or alternatively, the graph index framer may retrieve associated attributes (e.g., user data, entity data, resource-exchange device data, entity offer data, and/or the like) in real-time from the digital ledger network and may generate additional indexes and associated graphs and/or subgraphs based on various parameters.

For example, an initiated transaction may be detected by the event listener and an intelligent benefits framer may query a graph database and/or a digital ledger network to identify if there are any previous benefits for similar transactions framed based on existing indexes. Further, previous benefits identified may be analyzed by an intelligent benefits suggester in conjunction with additional data (e.g., user data, entity data, entity offer data, and/or the like) to generate a recommendation and frame the overall benefit. The recommendation along with a summarization of why the benefit, resource-exchange device, transaction mode, entity offer, and/or the like is being recommended may be transmitted to a user associated with the transaction. Based on this interpretation of the recommendation, the user may be able to update the initiated transaction to perform the initiated transaction with the recommended benefit if the user so chooses.

In some embodiments, if there is a match of the given transaction details to an index of a previously captured transaction that indicated that the previous transaction may have a high threat level, the transaction may be indicated as having a high threat level and may be automatically terminated. Further, a notification of the termination may be transmitted to a user device of a user associated with the terminated transaction. Additionally, or alternatively, a recommendation may be transmitted to the user advising them to terminate the transaction if a high threat level is detected rather than automatic termination.

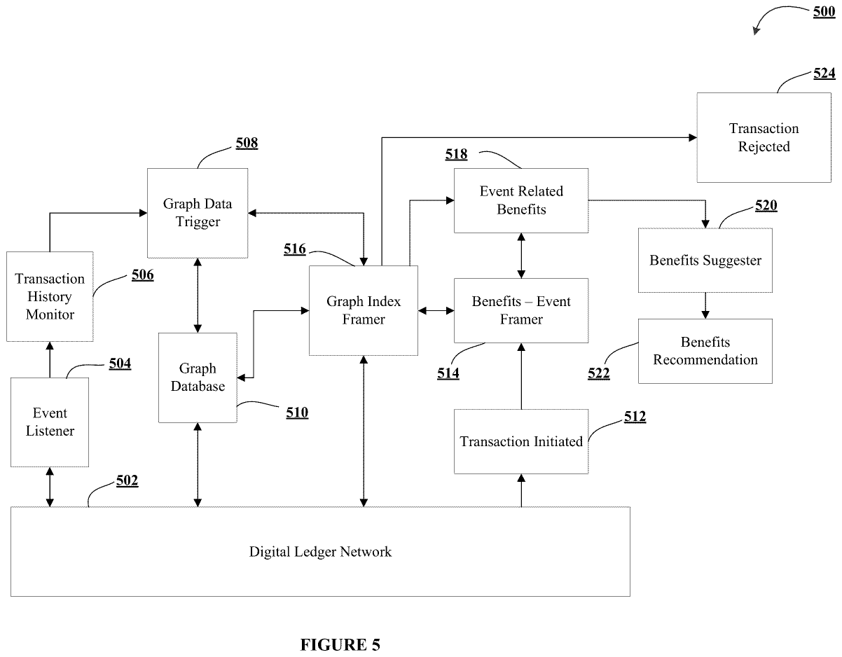

Accordingly, embodiments of the present disclosure may be configured to identify an initiated transaction on a collaborative digital ledger network (e.g., a blockchain consortium including a plurality of entities and a plurality of users), monitor the initiated transaction for the duration of a transaction lifecycle associated with the initiated transaction (e.g., similar to the transaction history monitor 506 as shown and described herein with respect to FIG. 5), and generate a first graph data trigger (e.g., listen for certain events associated with the transaction and automatically execute actions such as sending notifications, updating related data, enforcing rules, generating a graph for storage of data, generating a subgraph for storage of data, and/or the like) associated with initiation of the transaction.

Additionally, or alternatively, embodiments of the present disclosure may store the first graph data trigger as a graph in a graph database, identify, via the monitoring of the initiated transaction, an update to the initiated transaction to generate a second graph data trigger for storage as a first subgraph of one or more subgraphs in the graph database, retrieve, from the digital ledger network, associated attributes with the graph and the one or more subgraphs (e.g., data of previous transactions including one or more similar data elements to the initiated transaction such as user, vendor, entity, resource exchange device, product, and/or the like), and generate a plurality of indexes (e.g., a graph index for an entry in a graph database that enhances the speed and efficiency of searching, querying, and retrieving nodes or relationships based on specific properties) using the associated attributes and data of the graph and the one or more subgraphs associated with the initiated transaction (e.g., similar to the intelligent graph index framer 516 as shown and described herein with respect to FIG. 5).

Additionally, or alternatively, the system for intelligent graph data triggers for an opt-in collaborative digital ledger network may be configured to be operably coupled to an intelligent routing engine (e.g., a benefits recommendation engine). As such, embodiments of the present disclosure may be further configured to identify an initiated transaction on a collaborative opt-in digital ledger network, retrieve one or more graphs associated with the initiated transaction (e.g., search for indexes of graphs that may include graphs with similar data elements to the initiated transaction), analyze the one or more graphs associated with the initiated transaction, identify, via the analysis of the one or more graphs, one or more transaction related benefits associated with one or more similar transactions (e.g., data associated with previous transactions including one or more similar data elements such as a user, entity, threat level, vendor, product, resource exchange device, offers, and/or the like). Additionally, or alternatively, embodiments of the present disclosure may be configured to generate, using the one or more transaction related benefits, a recommendation for a user associated with the initiated transaction (e.g., an intelligent recommendation engine similar to the benefits suggester 520 as shown and described herein with respect to FIG. 5), transmit the recommendation to a user device associated with the user, and update, based on data received from the user device, the initiated transaction (e.g., the user may receive the recommendation and prefer completing the initiated transaction using the recommendation and transmit data indicating their choice).

What is more, the present invention provides a technical solution to a technical problem. As described herein, the technical problem includes recommending combinations of resource-exchange devices, entity offers, and/or the like to maximize user benefits while simultaneously identifying and mitigating high-threat transactions in real time. The technical solution presented herein allows for a system to identify an initiated transaction, monitor the initiated transaction, generate a first graph data trigger, store the first graph data trigger as a graph in a graph database, identify updates to the initiated transaction to generate additional graph data triggers for storage as a subgraphs in the graph database, retrieve associated attributes, and generate a plurality of indexes for storage in the graph database. Additionally, or alternatively, the technical solution presented herein allows for a system to identify an initiated transaction on a digital ledger network, retrieve one or more graphs, analyze the one or more graphs, identify one or more transaction related benefits, generate, a recommendation for a user associated with the initiated transaction, transmit the recommendation to a user device, receive approval of the recommendation, and/or update the initiated transaction. In particular, intelligent graph data triggers and/or an intelligent routing engine for an opt-in collaborative digital ledger network are an improvement over existing solutions to recommending combinations of resource-exchange devices, entity offers, and/or the like to maximize user benefits while simultaneously identifying and mitigating high-threat transactions in real time, (i) with fewer steps to achieve the solution, thus reducing the amount of computing resources, such as processing resources, storage resources, network resources, and/or the like, that are being used (e.g., by generating and storing graph-based indexes that dynamically link relevant transaction attributes, subgraphs, indexes, and/or the like in a single query, related data may be efficiently retrieved and analyzed over performing multiple independent queries, thus reducing the amount of computing resources, such as processing resources, storage resources, network resources, and/or the like, that are being used.), (ii) providing a more accurate solution to the problem, thus reducing the number of resources required to remedy any errors made due to a less accurate solution (e.g., by leveraging intelligent graph-based indexing and dynamically linking transaction attributes, resource-exchange devices, entity offers, and/or the like associated with transactions may be accurately identified while detecting high-threat transactions in real time, reducing false positives and erroneous recommendations, thus reducing the number of resources required to remedy any errors, such as reprocessing incorrect transaction data, reallocating storage resources, generating redundant notifications, and/or the like.), (iii) removing manual input and waste from the implementation of the solution, thus improving speed and efficiency of the process and conserving computing resources (e.g., by automatically querying the graph database to identify previous transactions with shared attributes, generating graph data triggers, and dynamically updating indexes with associated attributes, manual input in analyzing transaction data and identifying relevant entity offers may be eliminated, thus improving the speed and efficiency of the process and conserving computing resources, such as processing power and storage capacity, that would otherwise be consumed by repetitive manual operations), and (iv) determining an optimal amount of resources that need to be used to implement the solution, thus reducing network traffic and load on existing computing resources (e.g., by intelligently generating and linking subgraphs only for relevant attributes associated with an initiated transaction and dynamically updating indexes based on monitored transaction activity, an optimal amount of resources that need to be used to implement the solution may be determined by avoiding unnecessary data transmissions and minimizing redundant graph queries and index updates.). Furthermore, the technical solution described herein uses a rigorous, computerized process to perform specific tasks and/or activities that were not previously performed. In specific implementations, the technical solution bypasses a series of steps previously implemented, thus further conserving computing resources.

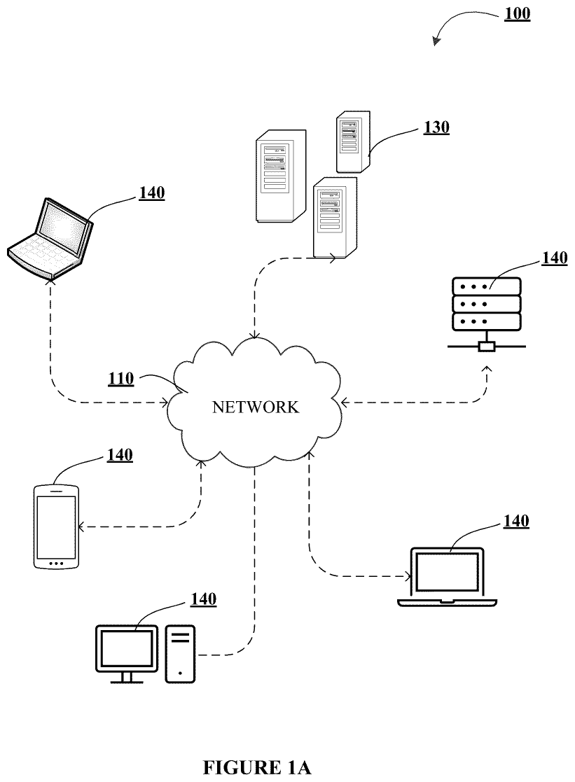

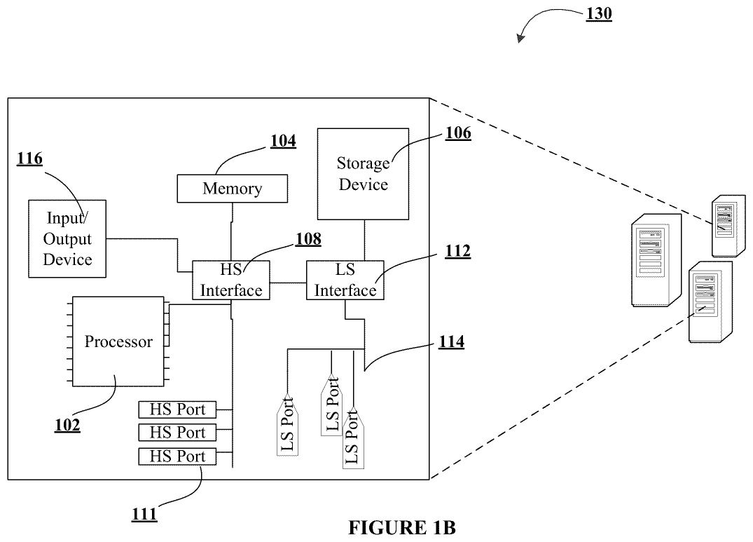

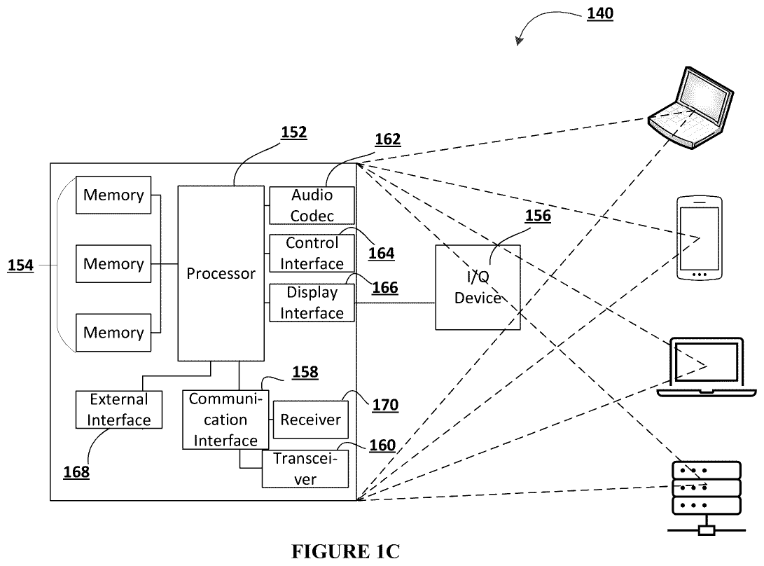

FIGS. 1A-1C illustrate technical components of an exemplary distributed computing environment 100 for intelligent graph data triggers and/or an intelligent routing engine for an opt-in collaborative digital ledger network, in accordance with an embodiment of the invention. As shown in FIG. 1A, the distributed computing environment 100 contemplated herein may include a system 130 (i.e., a system for intelligent graph data triggers and/or an intelligent routing engine for an opt-in collaborative digital ledger network), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

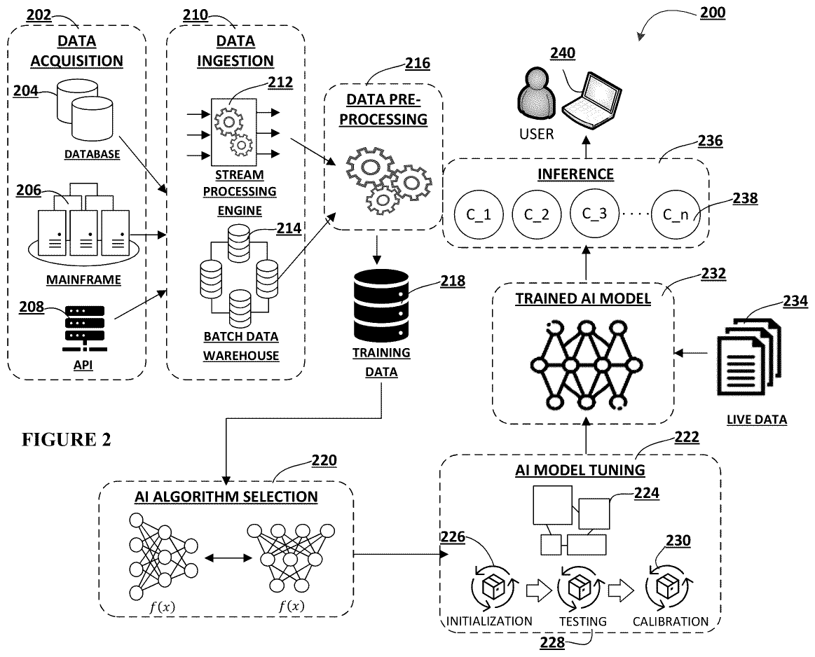

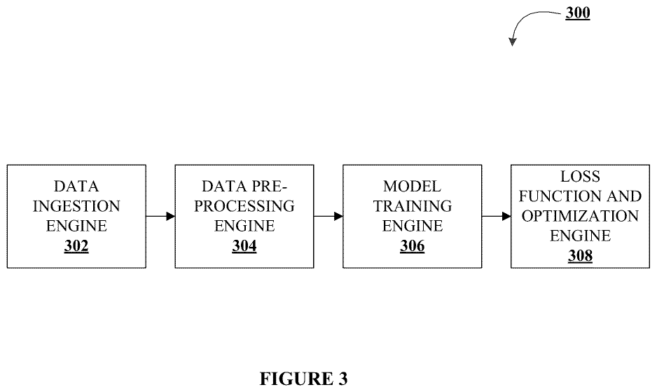

FIG. 2 illustrates an exemplary artificial intelligence (AI) engine subsystem architecture 200, in accordance with an embodiment of the disclosure. In some embodiments, the AI engine subsystem 200 may be included in a system (e.g., similar to the system 130 shown and described herein with respect to FIGS. 1A-1C). Additionally, or alternatively, the AI engine subsystem 200 may be a subsystem of another system (e.g., similar to the system 130 shown and described herein with respect to FIGS. 1A-1C) that is in communication with a system for intelligent graph data triggers and/or an intelligent routing engine for an opt-in collaborative digital ledger network (e.g., via a network similar to the network 110 as shown and described herein with respect to FIGS. 1A-1C). Further, the AI engine subsystem 200 may be a subsystem of another system (e.g., similar to the system 130 shown and described herein with respect to FIGS. 1A-1C) that is in communication with (e.g., via a network similar to the network 110 as shown and described herein with respect to FIGS. 1A-1C) a generative AI subsystem (e.g., similar to the generative AI subsystem 300 as shown and described herein with respect to FIG. 3). The AI engine subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 210, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the AI engine subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1,C_2 . . . C_n 238) live data 234 based on how similar they are to one another to solve exploratory challenges where little is known about the data, provide a description or label (e.g., C_1,C_2 . . . C_n 238) to live data 234, such as in classification, and/or the like. These categorized outputs, groups (clusters), or labels are then presented to the user input system 240. In still other cases, artificial intelligence engines that perform regression techniques may use live data 234 to predict or forecast continuous outcomes.

It will be understood that the embodiment of the AI engine subsystem 200 illustrated in FIG. 2 is exemplary and that other embodiments may vary. As another example, in some embodiments, the AI engine subsystem 200 may include more, fewer, or different components.

FIG. 3 illustrates an exemplary generative AI subsystem 300, in accordance with an embodiment of the invention. In some embodiments, the generative AI subsystem 300 may be included in a system (e.g., similar to the system 130 shown and described herein with respect to FIGS. 1A-1C). Additionally, or alternatively, the generative AI subsystem 300 may be a subsystem of another system (e.g., similar to the system 130 shown and described herein with respect to FIGS. 1A-1C) that is in communication with a system for intelligent graph data triggers and/or an intelligent routing engine for an opt-in collaborative digital ledger network (e.g., via a network similar to the network 110 as shown and described herein with respect to FIGS. 1A-1C). Further, the generative AI subsystem 300 may be a subsystem of another system (e.g., similar to the system 130 shown and described herein with respect to FIGS. 1A-1C) that is in communication with (e.g., via a network similar to the network 110 as shown and described herein with respect to FIGS. 1A-1C) an AI engine subsystem (e.g., similar to the AI engine subsystem 200 as shown and described herein with respect to FIG. 2).

The generative AI subsystem 300 may include a data ingestion engine 302, a data pre-processing engine 304, a model training engine 306, and a loss function and optimization engine 308. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, and/or from streams. For a large language model (“LLM”), text data may originate from sources such as web scrapes, social media, large public text datasets, and/or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, and/or any other logical ordering.

In machine learning, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training engine 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306 may implement optimization techniques such as gradient clipping, learning rate scheduling, and mixed-precision training. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float33) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

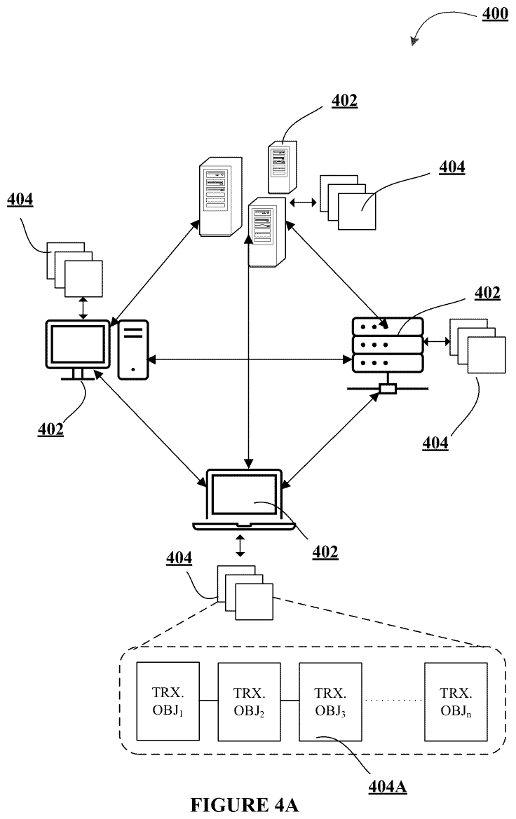

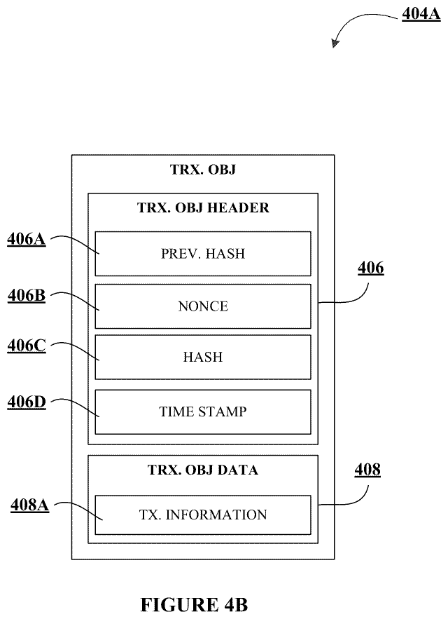

FIGS. 4A-4B illustrate an exemplary distributed ledger technology (DLT) architecture, in accordance with an embodiment of the invention. DLT may refer to the protocols and/or supporting infrastructure that allow computing devices (peers) in different locations to propose and validate transactions and update records in a synchronized way across a network (e.g., similar to the digital ledger network 502 as shown and described herein with respect to FIG. 5). Accordingly, DLT is based on a decentralized model, in which the se peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the transaction objects before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically execute all of or parts of an agreement and are stored on a DLT platform. The code can either be the sole manifestation of the agreement between the parties or might complement a traditional text-based contract and execute certain provisions, such as transferring funds from Party A to Party B. The code itself may be replicated across multiple nodes (peers) and, therefore, may benefit from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world may send transactions to and expect to see them included if they are valid, and anyone in the world can participate in the consensus process for determining which transaction objects are added to the distributed ledger and what the current state of each transaction object is. A public distributed ledger is generally considered to be fully decentralized. On the other hand, a fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that at least 10 members must sign every transaction object in order for the transaction object to be valid. The right to read such a distributed ledger may be public or restricted to the participants. These distributed ledgers may be considered partially decentralized.

As shown in FIG. 4A, the exemplary DLT architecture 400 may include a distributed ledger 404 being maintained on multiple devices (nodes) 402 that are authorized to keep track of the distributed ledger 404. For example, the nodes 402 may be computing devices such as the system 130 and the client device(s) 140. One node of the nodes 402 in the DLT architecture 400 may have a complete or partial copy of the entire distributed ledger 404 or may have a set of transactions and/or transaction objects 404A on the distributed ledger 404. Transactions may be initiated at a node and communicated to the nodes 402 in the DLT architecture 400. Any of the nodes 402 may validate a transaction, record the transaction to its copy of the distributed ledger, and/or broadcast the transaction, its validation (in the form of a transaction object), and/or other data to other nodes.

As shown in FIG. 4B, an exemplary transaction object 404A may include a transaction object header 406 and transaction object data 408. The transaction object header 406 may include a cryptographic hash of a previous transaction object 406A, a nonce 406B (e.g., a randomly generated 32-bit whole number when the transaction object 404A is created), a cryptographic hash of the current transaction object 406C wedded to the nonce 406B, and/or a time stamp 406D. The transaction object data 408 may include transaction information 408A being recorded. Once the transaction object 404A is generated, the transaction information 408A is considered signed and forever tied to the nonce 406B and the cryptographic hash 406C. Once generated, the transaction object 404A is then deployed on the distributed ledger 404. At this time, a distributed ledger address may be generated for the transaction object 404A (e.g., an indication of where the transaction object 404A is located on the distributed ledger 404) and may be captured for recording purposes. Once deployed, the transaction information 408A is considered recorded in the distributed ledger 404.

FIG. 5 illustrates a flowchart 500 for intelligent graph data triggers and/or an intelligent routing engine for an opt-in collaborative digital ledger network, in accordance with an embodiment of the disclosure. In some embodiments, a system (e.g., similar to one or more of the systems shown and described herein with respect to FIGS. 1A-1C) may perform one or more of the steps of the flowchart 500. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of the flowchart 500. In some embodiments, an artificial intelligence engine (e.g., similar to the AI engine subsystem 200 as shown and described herein with respect to FIG. 2) may perform one or more of the steps of the flowchart 500. Additionally, or alternatively, a generative artificial intelligence engine (e.g., similar to the generative AI subsystem 300 as shown and described herein with respect to FIG. 3) may perform one or more of the steps of the flowchart 500. In some embodiments, a digital ledger network (e.g., similar to the distributed ledger 404 as shown and described herein with respect to FIG. 4) may be configured to perform, assist in, store data in, and/or the like one or more steps of the flowchart 500.

In some embodiments, the flowchart 500 may include a digital ledger network 502 (e.g., an opt-in collaborative blockchain consortium). The digital ledger network 502 may include a plurality of users and a plurality of entities that opted in to collaborating with all parties includes in the digital ledger network 502. Further, the digital ledger network may be configured to store data related to each user of the plurality of users and each entity of the plurality of entities. Additionally, or alternatively, the digital ledger network 502 may further include a repository of data related to transaction history for transactions that previously occurred between parties included in the digital ledger network 502. Further, the transaction history repository of previous transactions may be configured to serve as a graph database as described herein.

As a transaction is initiated between parties included in the digital ledger network 502, the initiated transaction 512 may be detected by an event listener 504. The event listener 504 may be configured to continuously monitor the digital ledger network 502 for activities related to the initiated transaction 512, capturing real-time updates related to the initiated transaction 512. As updates to the initiated transaction 512 are detected by the event listener 504, data related to the update may be transmitted to a transaction history monitor 506. The transaction history monitor 506 may be configured to analyze captured events of the initiated transaction 512 and trigger the creation of graph data, subgraphs, associated indexes, and/or the like via an intelligent graph data trigger 508. The intelligent graph data trigger 508 may be configured to automatically generate and update graph data and/or subgraph data in response to detected transaction events, such as changes in the status or attributes of the initiated transaction 512. Further, the intelligent graph data trigger 508 may dynamically identify and link relevant attributes, generating corresponding triggers to store transaction-related data in a graph database 510 and/or a transaction history repository of the digital ledger network 502.

Upon detection of the initiated transaction 512, a benefits—event framer 514 may analyze data of the initiated transaction 512 and identify relevant events that may trigger potential benefits associated with the initiated transaction 512. The event-related benefits 518 detected by the benefits—event framer 514 may then be identified by evaluating previous transactions and associated attributes (e.g., resource exchange devices, historical rewards, entity offers, transaction modes, and/or the like). A benefits suggester 520 may use this information to dynamically recommend the most relevant and beneficial resource-exchange devices, offers, and/or the like based on the transaction's characteristics, the user's past interactions, and/or previous related transactions. The benefits suggester 520 may utilize AI-driven algorithms that leverage machine learning models to analyze historical transaction data, user preferences, associated attributes, and/or the like related to the initiated transaction 512. By processing this information, the benefits suggester 520 intelligently identifies patterns and predicts the most relevant resource-exchange devices, entity offers, and/or the like for the initiated transaction 512. The benefits suggester 520 may continuously adapt its recommendations based on real-time transaction monitoring and past behavior, ensuring suggestions are both contextually accurate and tailored to maximize user benefits. In some embodiments, the benefits suggester 520 may be configured as a black box model such that it may function as any suitable model for searching and identifying relevant benefits based on transaction data, user preferences, associated attributes, and/or the like. Using the intelligent benefits suggester 520, a benefits recommendation 522 may be generated and transmitted to a user device associated with the initiated transaction 512, accompanied by a clear interpretation of why the suggested benefit or payment method is the most advantageous for the initiated transaction 512, allowing the user to make an informed decision and maximize potential benefits.

In some embodiments, an intelligent graph index framer 516 may be configured to dynamically generate and/or update one or more indexes associated with graphs and subgraphs stored in the graph database 510 and/or in a transaction history repository of the digital ledger network 502. The graph index framer 516 may include an AI-driven framework that intelligently analyzes attributes associated with a transaction, including transaction details, associated entity offers, historical transaction data, and/or the like, to generate highly relevant indexes for efficient querying and retrieval. Additionally, or alternatively, the graph index framer 516 may continuously monitor updates to the graphs and subgraphs in real time and automatically modify the associated indexes to ensure that the most current and contextually relevant data is available for analysis and recommendation generation. By optimizing the indexing process, the graph index framer 516 reduces computational overhead and enhances the speed and accuracy of graph-based operations.

In some embodiments, a transaction may not be fully processed and may result in a transaction rejection 524 (e.g., termination of the transaction). In such embodiments, the transaction rejection 524 may occur if the initiated transaction 512 is determined to have a high threat level based on an analysis of its associated attributes, including attributes of the initiating entity, historical transaction patterns, any detected anomalies, and/or the like. The determination may be performed using a trained model that may evaluate correlations between the initiated transaction 512 and prior transactions that resulted in high-threat outcomes. Additionally, or alternatively, the transaction rejection 524 may be triggered by the intelligent graph data trigger 508 if it detects an association between the initiated transaction 512 and one or more subgraphs linked to high-threat patterns.

Additionally, or alternatively, the transaction rejection 524 may be carried out by transmitting a notification to a user device associated with the initiated transaction 512 and/or an entity system that may automatically suspend or cancel the initiated transaction 512. The notification may include a recommendation to terminate the initiated transaction 512 and may be generated by the benefits suggester 520 that considers the potential losses, resource inefficiencies, and/or reputational harm associated with completing a high-threat transaction. In some embodiments, upon detection of a termination event, the graph and any subgraphs associated with the initiated transaction 512 may be removed from the graph database 510 and/or in transaction history repository of the digital ledger network 502 to prevent retention of data linked to an unfulfilled or invalidated transaction, thereby ensuring data integrity and optimizing database storage efficiency. Additionally, or alternatively, data related to the initiated transaction 512 may be retained during the transaction rejection 524 if the transaction rejection 524 occurred due to a high threat level.

The flowchart 500 may include additional embodiments, such as any single embodiment or any combination of embodiments described herein. Although FIG. 5 shows example blocks of the flowchart 500, in some embodiments, the flowchart 500 may include additional blocks, fewer blocks, different blocks, or differently arranged blocks than those depicted in FIG. 5. Additionally, or alternatively, two or more of the blocks of the flowchart 500 may be performed in parallel.

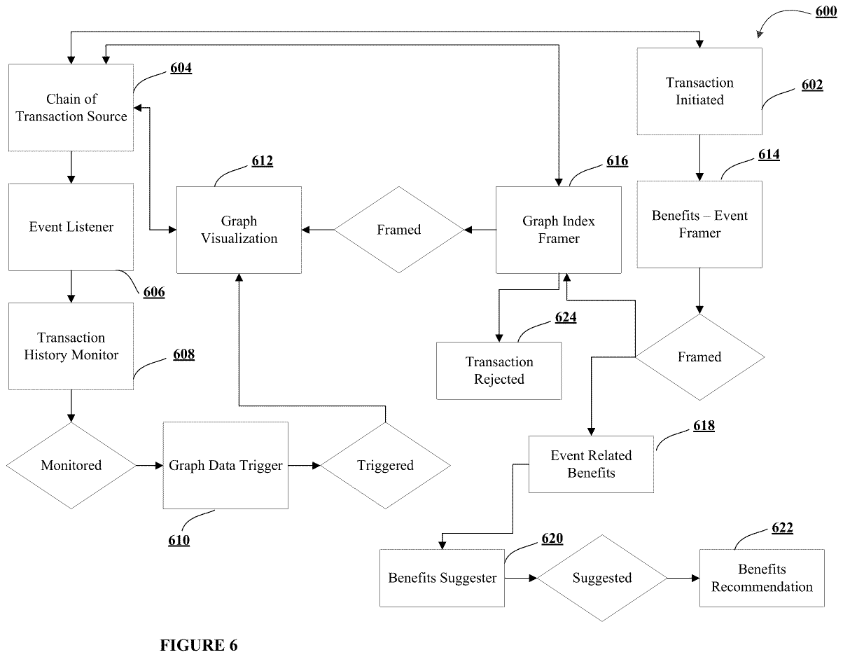

FIG. 6 illustrates another flowchart 600 for intelligent graph data triggers and/or an intelligent routing engine for an opt-in collaborative digital ledger network, in accordance with an embodiment of the disclosure. In some embodiments, a system (e.g., similar to one or more of the systems shown and described herein with respect to FIGS. 1A-1C) may perform one or more of the steps of the flowchart 600. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of the flowchart 600. In some embodiments, an artificial intelligence engine (e.g., similar to the AI engine subsystem 200 as shown and described herein with respect to FIG. 2) may perform one or more of the steps of the flowchart 500. Additionally, or alternatively, a generative artificial intelligence engine (e.g., similar to the generative AI subsystem 300 as shown and described herein with respect to FIG. 3) may perform one or more of the steps of the flowchart 600. In some embodiments, a digital ledger network (e.g., similar to the distributed ledger 404 as shown and described herein with respect to FIG. 4) may be configured to perform, assist in, store data in, and/or the like one or more steps of the flowchart 600.

In some embodiments, the flowchart 600 may include a transaction being initiated 602 in a digital ledger network (e.g., a blockchain consortium and/or similar to the digital ledger network 502 as shown and described herein with respect to FIG. 5) between two parties (e.g., a user and a vendor) within the digital ledger network. Additionally, or alternatively, the transaction initiation 602 may occur when one party (e.g., a user) transmits a request to engage in a resource exchange with another party (e.g., an entity) using a resource-exchange device. The initiated transaction may include transaction parameters such as the identity of the parties, the type and quantity of resources to be exchanged, a timestamp, cryptographic signatures, metadata associated with the transaction, and/or the like.

Upon initiation of the transaction 602, an event listener 606 may be configured to monitor the digital ledger network for transaction-related events of the transaction. The event listener 606 may, in some embodiments, include a software module or component that listens for specific signals, messages, and/or state changes indicative of transaction initiation 602 and/or transaction updates. Further, the event listener 606 may detect the transaction initiation 602 and capture relevant information regarding the transaction (e.g., transaction details, attributes, and/or the like). In some embodiments, upon identifying the transaction initiation 602, the event listener 606 may pass the captured information to a transaction history monitor 608 for continuous monitoring.

In some embodiments, the transaction history monitor 608 may be configured to track and observe the lifecycle of the transaction by monitoring updates or changes to the digital ledger network where the transaction resides. Further, the transaction history monitor 608 may periodically poll the digital ledger network and/or the event listener 606 to retrieve updated transaction information or may receive push notifications from the digital ledger network and/or the event listener 606 when any modifications occur. In some embodiments, the transaction history monitor 608 and/or the event listener 606 may identify changes to a chain of transaction source 604, including updates to the transaction state, validation status, block inclusion, and/or subsequent modifications that may impact the outcome or status of the transaction.

Upon detecting or receiving notification of an update or modification to the transaction or the chain of transaction source 604, the transaction history monitor 608 may, in some embodiments, generate a graph data trigger 610 to initiate the creation or update of graph data models representing the transaction and its related attributes. Further, the graph data trigger 610 may include information pertaining to the transaction, such as transaction identifiers, involved parties, attributes, and/or any associated metadata that is relevant for constructing the graph representation. Additionally, or alternatively, the generation of the graph data trigger 610 may also be configured to occur when a predetermined condition is satisfied (e.g., successful validation of the transaction, confirmation of the transaction by a specified number of nodes within the digital ledger network, detection of an update to the transaction, and/or the like).

Following the generation of the graph data trigger 610, a graph visualization library or software (e.g., GraphGL or other graph processing frameworks) 612 may, in some embodiments, be used to encapsulate the data within the trigger to generate one or more graphs and/or subgraphs representing the transaction and its associated relationships. Further, the graph visualization library 612 may analyze the transaction data to determine how the entities, resources, and/or attributes associated with the transaction relate to one another. Based on this analysis, the graph visualization library 612 may construct a visual or structural representation of the data in the form of a graph. For example, nodes may represent entities, resources, or transaction components, and edges may represent relationships, interactions, or dependencies between the nodes.

In some embodiments, the generated graph and/or subgraphs may be stored in a graph database and/or in a transaction repository of the digital ledger network for further analysis and querying. Additionally, or alternatively, the graph database and/or the transaction repository may include a specialized database system optimized for storing, retrieving, and managing graph-structured data. The graph and/or subgraphs may be associated with unique identifiers, metadata, and timestamps that facilitate efficient retrieval and query operations. Additionally, or alternatively, the graph database and/or transaction repository of the digital ledger network may be partitioned or segmented into different subsections, where graphs representing similar types of transactions or attributes may be grouped together for optimized storage and retrieval.

Concurrently or subsequently, details of the initiated transaction and the generated graph and/or subgraphs of data related to the transaction may be transmitted to a graph index framer 616 for the generation of indexes associated with the newly created graphs. The graph index framer 616 may include a software module configured to analyze the structure and attributes of the graph and generate one or more indexes that facilitate rapid searching, querying, and retrieval of graph data. Further, the generated indexes may include information about key attributes of the graph, node relationships, transaction states, and any associated metadata. In some embodiments, the graph index framer 616 may generate primary and secondary indexes, ensuring that future queries involving similar transactions or related attributes can be executed with minimal latency and reduced computational overhead. Additionally, or alternatively, the indexes generated by the graph index framer 616 may be converted into a graphical format for storage and analysis by the graph visualization library 612. For example, this conversion may involve transforming the indexed attributes, relationships, and metadata into node and edge representations that mirror the structure of the corresponding graphs. The resulting graphical format of the indexes may be stored alongside the original graphs and/or subgraphs in and/or in a subsection of the graph database and/or the transaction repository of the digital led ger network.

In some embodiments, the generated indexes may be linked to the respective graphs and/or subgraphs stored in the graph database and/or the transaction repository of the digital ledger network, allowing for efficient location and retrieval of relevant graphs when subsequent analysis or operations involving the transaction may be required. As will be appreciated by one of ordinary skill in the art in view of the present disclosure, by maintaining an updated and indexed graph representation of the transaction data, enhanced querying, analysis, and visualization of complex relationships within the digital ledger network may be facilitated, thereby improving the accuracy and efficiency of downstream processes.

In some embodiments, after transaction initiation 602, a benefits-event framer 614 may be invoked to analyze transaction data, graph data of previous transactions, any associated entity offers or benefits, and/or the like. In such embodiments, the benefits-event framer 614 may extract and frame one or more benefits associated with the initiated transaction by considering attributes such as transaction type, entity preferences, historical transaction data, user-specific benefits linked to prior transactions, resource-exchange devices, and/or the like. The framing process may involve correlating transaction-related data with previously identified benefits or entity offers to identify relevant benefits that may be applicable to the current transaction.

In some embodiments, the benefits-event framer 614 may then pass the framed benefits to the graph index framer 616 for generating indexes that link the benefits to the graphs and/or subgraphs associated with the transaction. Further, these indexes may be stored in the graph database and/or the transaction repository of the digital ledger network to enable efficient retrieval and querying of benefits data in future transactions. Additionally, or alternatively, the benefits-event framer 614 may pass event-related benefits 618 to an intelligent benefits suggester 620 that may employ AI models to analyze the framed benefits and generate a benefits recommendation 622 for the user that may result in a minimal amount of resource loss for the user in the transaction and/or maximize any type of benefit as set by the user. In other words, the benefits suggester 620 may compare the identified benefits with past benefits associated with similar transactions, consider user preferences, and evaluate potential outcomes to generate a recommendation that maximizes value for the user. For example, the benefits suggester 620 may identify that the user has access to a resource exchange device that returns a higher portion of resource spent on the transaction than another resource exchange device and that one entity of a plurality of entities requires less resources for completion of the transaction. As such, the benefits suggester 620 may generate a recommendation including this combination for the user to use to complete the transaction.

Simultaneously, the benefits-event framer 614 may, in some embodiments, analyze historical transaction data to identify patterns of potential threats associated with transactions that exhibit similarity to the initiated transaction. By examining prior transactions that were flagged, rejected, and/or terminated due to identified threats, the benefits-event framer 614 may detect emerging threats that could potentially compromise the current transaction. Upon identifying such threats, an automatic rejection or termination of the transaction 624 may be initiated to prevent further progression. Additionally, or alternatively, a notification may be generated that includes a recommendation of termination of the transaction 624 and transmitted to a user device for further action.

The benefits recommendation 622 generated by the benefits suggester 620 may, in some embodiments, further include a contextual analysis of the identified threats, allowing the user to make an informed decision regarding the transaction. In some embodiments, the benefits suggester 620 may dynamically adjust the benefits recommendation based on detected threats, ensuring that the user is presented with an optimized combination of benefits while mitigating potential threats.

The flowchart 600 may include additional embodiments, such as any single embodiment or any combination of embodiments described herein. Although FIG. 6 shows example blocks of the flowchart 600, in some embodiments, the flowchart 600 may include additional blocks, fewer blocks, different blocks, or differently arranged blocks than those depicted in FIG. 6. Additionally, or alternatively, two or more of the blocks of the flowchart 600 may be performed in parallel.

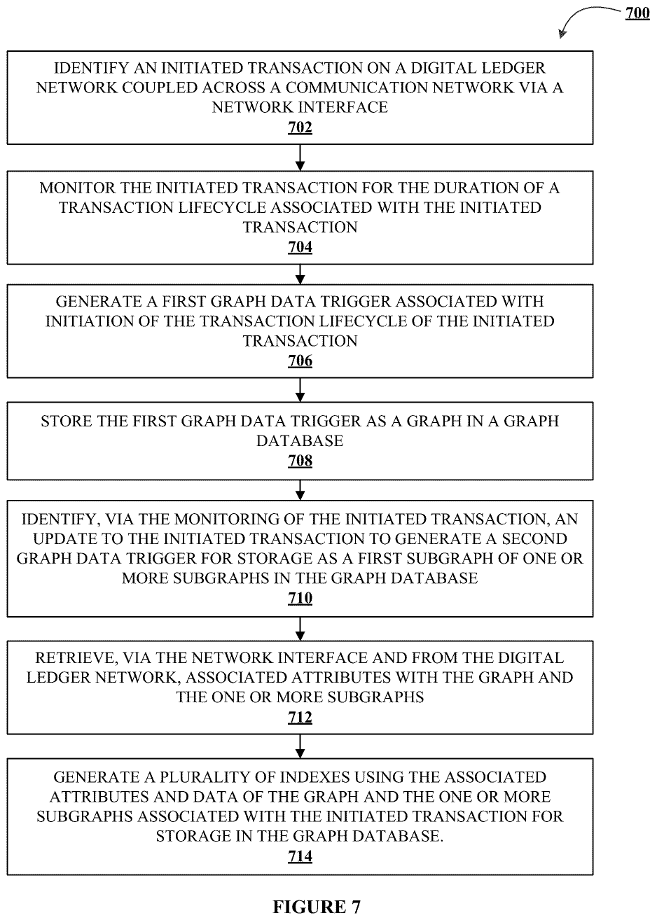

FIG. 7 illustrates a process flow 700 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 700. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 700. In some embodiments, an artificial intelligence engine (e.g., similar to the AI engine subsystem 200 as shown and described herein with respect to FIG. 2) may perform one or more of the steps of process flow 700. Additionally, or alternatively, a generative artificial intelligence engine (e.g., similar to the generative AI subsystem 300 as shown and described herein with respect to FIG. 3) may perform one or more of the steps of process flow 700. In some embodiments, a digital ledger network (e.g., similar to the distributed ledger 404 as shown and described herein with respect to FIG. 4) may be configured to perform, assist in, store data in, and/or the like one or more steps of process flow 700.

In some embodiments, and as shown in block 702, the process flow 700 may include the step of identifying an initiated transaction on a digital ledger network coupled across a communication network via a network interface. The digital ledger network may include multiple entities that interact within an ecosystem, such as resource-exchange device providers, users, and offering third parties. The initiated transaction may be detected via an event listener (e.g., similar to the event listener 504 as shown and described herein with respect to FIG. 5) configured to capture signals or messages indicative of transaction initiation. Upon identification, the system may proceed to monitor the initiated transaction for the duration of a transaction lifecycle.

In some embodiments, and as shown in block 704, the process flow 700 may include the step of monitoring the initiated transaction for the duration of a transaction lifecycle associated with the initiated transaction. The monitoring may be performed by a transaction history monitor (e.g., similar to the transaction history monitor 506 as shown and described herein with respect to FIG. 5) that continuously evaluates updates associated with the initiated transaction. The monitoring process may capture data indicative of various transaction stages, including initiation, processing, and completion. The transaction lifecycle may also include identifying any anomalous activity associated with the initiated transaction, which may be used to trigger further evaluation or generate alerts where necessary.

In some embodiments, and as shown in block 706, the process flow 700 may include the step of generating a first graph data trigger associated with initiation of the transaction lifecycle of the initiated transaction. The first graph data trigger may be created based on the metadata and event signals detected during the identification of the initiated transaction. This graph data trigger may serve as the initial data point for building a graph that represents the transaction and its associated lifecycle. In some embodiments, the generated graph data trigger may include a collection of attributes relevant to the initiated transaction, which may be used to form a preliminary structure for further analysis and monitoring.

In some embodiments, and as shown in block 708, the process flow 700 may include the step of storing the first graph data trigger as a graph in a graph database. The graph database may be configured to organize and store a collection of graph data triggers that are generated for various initiated transactions. Each graph may represent a distinct transaction and its associated lifecycle, with vertices and edges capturing key attributes and relationships between participants. As will be appreciated by one of ordinary skill in the art in view of the present disclosure, the graph database may allow for efficient retrieval and analysis of the stored graphs, enabling further insights into transaction behavior and lifecycle stages.

In some embodiments, and as shown in block 710, the process flow 700 may include the step of identifying, via the monitoring of the initiated transaction, an update to the initiated transaction to generate a second graph data trigger for storage as a first subgraph of one or more subgraphs in the graph database. The monitoring system may track changes or modifications in the transaction data, such as changes in the resource-exchange device used, the transaction amount, the status of the transaction, and/or the like. Upon detecting an update, the system may generate an appropriate trigger to reflect the change, ensuring that the transaction data remains accurate and up to date throughout the transaction lifecycle. Additionally, or alternatively, the second graph data trigger may capture the identified update to the initiated transaction and incorporate it into the graph structure. The generated subgraph may represent an extension of the initial graph, reflecting changes in transaction attributes, relationships, and states. The subgraph may be linked to the original graph, allowing for a comprehensive representation of the evolving transaction lifecycle.

In some embodiments, as the initiated transaction proceeds through the transaction lifecycle, a plurality of additional updates to the initiated transaction may occur and be detected via the monitoring process. In such embodiments, a plurality of additional graph data triggers, at least one per detected update, may be generated and stored as a plurality of additional subgraphs (e.g., a third subgraph, a fourth subgraph, and/or the like) in the graph database. As will be understood by one or ordinary skill in the art in view of the present disclosure, structures of related graphs and subgraph may take many forms such as a single chain, one or more branches, and/or the like.

In some embodiments, and as shown in block 712, the process flow 700 may include the step of retrieving, via the network interface and from the digital ledger network, associated attributes with the graph and the one or more subgraphs. The associated attributes may include data related to transaction parameters, entity interactions, resource-exchange device usage, any updates recorded throughout the transaction lifecycle, entity offers associated with a resource related to the initiated transaction, previous related transactions, and/or the like. The retrieval process may leverage intelligent query mechanisms to ensure that the most relevant and updated attributes are collected for further analysis and storage. These attributes may be critical for enhancing transaction intelligence, identifying patterns, and/or enabling dynamic indexing.

In some embodiments, and as shown in block 714, the process flow 700 may include the step of generating a plurality of indexes using the associated attributes and data of the graph and the one or more subgraphs associated with the initiated transaction for storage in the graph database. In such embodiments, the indexes may be generated by an intelligent Graph Index Framer that analyzes transaction attributes, updates, and/or relationships captured within the graph structure. These indexes may facilitate efficient query processing, enabling rapid identification of relevant data points, including potential anomalies or patterns indicative of suspicious activity. The generated indexes may be stored in the graph database to maintain a comprehensive and dynamically evolving representation of transaction activity.

The process flow 700 may include additional embodiments, such as any single embodiment or any combination of embodiments described herein. Although FIG. 7 shows example blocks of the process flow 700, in some embodiments, the process flow 700 may include additional blocks, fewer blocks, different blocks, or differently arranged blocks than those depicted in FIG. 7.

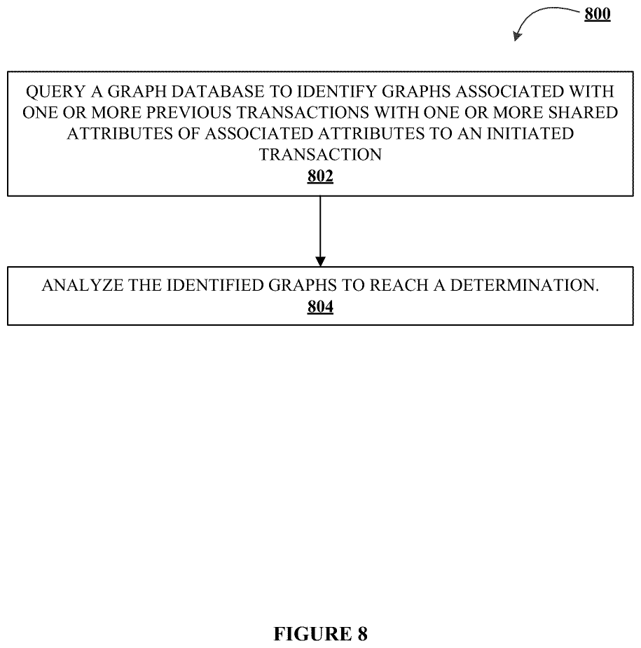

FIG. 8 illustrates another process flow 800 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 800. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 800. In some embodiments, an artificial intelligence engine (e.g., similar to the AI engine subsystem 200 as shown and described herein with respect to FIG. 2) may perform one or more of the steps of process flow 800. Additionally, or alternatively, a generative artificial intelligence engine (e.g., similar to the generative AI subsystem 300 as shown and described herein with respect to FIG. 3) may perform one or more of the steps of process flow 800. In some embodiments, a digital ledger network (e.g., similar to the distributed ledger 404 as shown and described herein with respect to FIG. 4) may be configured to perform, assist in, store data in, and/or the like one or more steps of process flow 800.

In some embodiments, and as shown in block 802, the process flow 800 may include the step of querying a graph database to identify graphs associated with one or more previous transactions with one or more shared attributes of associated attributes to an initiated transaction. In such embodiments, the query may leverage intelligent indexing mechanisms to search for relevant graphs that share transaction characteristics, such as resource-exchange device usage, entity interactions, transaction types, and/or the like. Additionally, or alternatively, the query may search through indexes that are linked to the graphs, where such indexes may include metadata or other attributes that correlate with the associated attributes of the initiated transaction. The identified graphs may be used to compare historical transaction patterns and extract meaningful insights that may inform the analysis of the initiated transaction. In some embodiments, the step of block 802 of the process flow 800 may be performed following and/or in conjunction with the step of block 712 of the process flow 700 as shown and described herein with respect to FIG. 7.

In some embodiments, and as shown in block 804, the process flow 800 may include the step of analyzing the identified graphs to reach a determination. The analysis may involve evaluating patterns, trends, and relationships among transaction attributes captured within the identified graphs. The analysis may further include comparing the attributes of the initiated transaction with those of the identified graphs to detect similarities, anomalies, deviations, and/or the like that may indicate relevant transaction behaviors. Additionally, or alternatively, the analysis may include using machine learning models or graph-based algorithms to derive insights from the interconnected data and provide recommendations or alerts based on the detected patterns. In some embodiments, the determination may be directed to proposed modifications to the initiated transaction including, but not limited to, using an entity offer for the initiated transaction, using a certain resource exchange device, cancelling the initiated transaction due to an identified threat, and/or the like.

The process flow 800 may include additional embodiments, such as any single embodiment or any combination of embodiments described herein. Although FIG. 8 shows example blocks of the process flow 800, in some embodiments, the process flow 800 may include additional blocks, fewer blocks, different blocks, or differently arranged blocks than those depicted in FIG. 8.

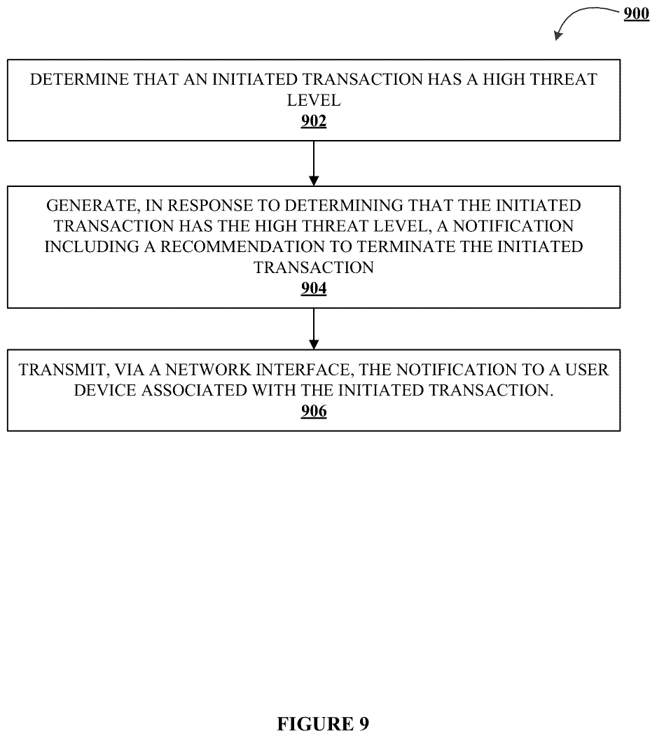

FIG. 9 illustrates another process flow 900 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 900. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 900. In some embodiments, an artificial intelligence engine (e.g., similar to the AI engine subsystem 200 as shown and described herein with respect to FIG. 2) may perform one or more of the steps of process flow 900. Additionally, or alternatively, a generative artificial intelligence engine (e.g., similar to the generative AI subsystem 300 as shown and described herein with respect to FIG. 3) may perform one or more of the steps of process flow 900. In some embodiments, a digital ledger network (e.g., similar to the distributed ledger 404 as shown and described herein with respect to FIG. 4) may be configured to perform, assist in, store data in, and/or the like one or more steps of process flow 900.

In some embodiments, and as shown in block 902, the process flow 900 may include the step of determining that an initiated transaction has a high threat level. In such embodiments, the determination may be based on a comparison of attributes associated with the initiated transaction against predefined threat parameters or criteria stored in the graph database. Further, the threat level may be assessed by analyzing transaction patterns, resource-exchange device usage, and/or entity interactions in relation to historical data. Additionally, or alternatively, the determination may include comparing the initiated transaction with one or more previous transactions that had a high threat level and shared similar attributes. Such comparisons may enhance the identification of suspicious activity by detecting patterns or trends indicative of a potential threat. The determination of a high threat level may trigger subsequent actions to mitigate any identified threat. In some embodiments, the step of block 902 of the process flow 900 may be performed following and/or in conjunction with the step of block 804 of the process flow 800 as shown and described herein with respect to FIG. 8.

In some embodiments, and as shown in block 904, the process flow 900 may include the step of generating a notification including a recommendation to terminate the initiated transaction. In such embodiments, the notification may include information regarding the identified high threat level, the attributes contributing to the threat determination, and/or a recommendation to terminate the initiated transaction to prevent potential threats. Additionally, or alternatively, the notification may include a summary of previous transactions with similar attributes that were determined to have high threat levels, providing context for the recommendation. Further, the notification may be formatted for rapid comprehension by a user to facilitate timely decision-making and response.

In some embodiments, and as shown in block 906, the process flow 900 may include the step of transmitting, via a network interface, the notification to a user device associated with the initiated transaction. In such embodiments, the notification may be transmitted over a secure communication channel to ensure data integrity and confidentiality. Additionally, or alternatively, the notification may be delivered using multiple communication protocols and/or formats to ensure successful delivery, such as push notifications, email messages, and/or SMS alerts. The transmitted notification may enable the user to take appropriate action, including terminating the initiated transaction or confirming its legitimacy.

The process flow 900 may include additional embodiments, such as any single embodiment or any combination of embodiments described herein. Although FIG. 9 shows example blocks of the process flow 900, in some embodiments, the process flow 900 may include additional blocks, fewer blocks, different blocks, or differently arranged blocks than those depicted in FIG. 9.

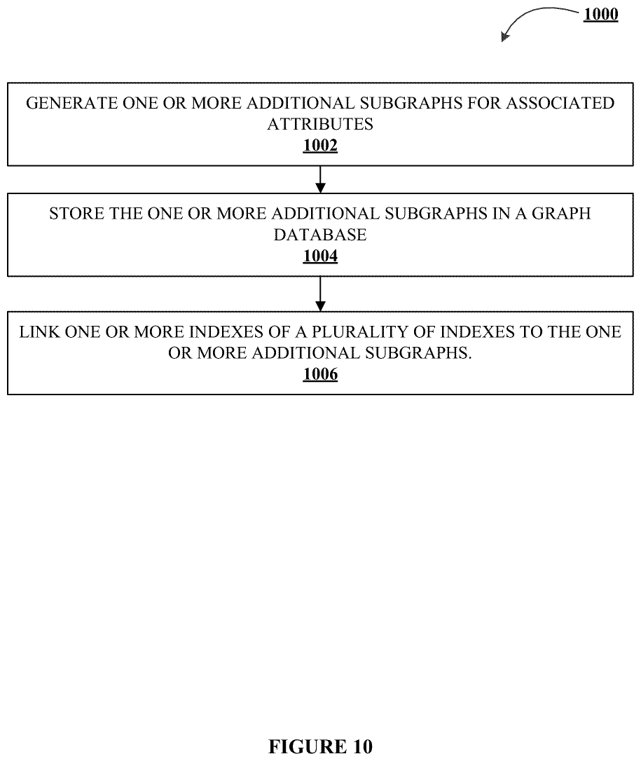

FIG. 10 illustrates another process flow 1000 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 1000. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 1000. In some embodiments, an artificial intelligence engine (e.g., similar to the AI engine subsystem 200 as shown and described herein with respect to FIG. 2) may perform one or more of the steps of process flow 1000. Additionally, or alternatively, a generative artificial intelligence engine (e.g., similar to the generative AI subsystem 300 as shown and described herein with respect to FIG. 3) may perform one or more of the steps of process flow 1000. In some embodiments, a digital ledger network (e.g., similar to the distributed ledger 404 as shown and described herein with respect to FIG. 4) may be configured to perform, assist in, store data in, and/or the like one or more steps of process flow 1000.

In some embodiments, and as shown in block 1002, the process flow 1000 may include the step of generating one or more additional subgraphs for associated attributes. In such embodiments, the one or more additional subgraphs may include representations of activity information, transactional relationships, attributes derived from monitoring initiated transactions on a digital ledger network, and/or any attributes related to transactions as described herein. Additionally, or alternatively, the one or more additional subgraphs may extend the graph by incorporating new data points identified during subsequent transactions that share common attributes with the initiated transaction. In some embodiments, the step of block 1002 of the process flow 1000 may be performed following and/or in conjunction with the step of block 714 as shown and described herein with respect to FIG. 7.

In some embodiments, and as shown in block 1004, the process flow 1000 may include the step of storing the one or more additional subgraphs in a graph database. In such embodiments, the one or more additional subgraphs may be stored in association with previously generated graphs and subgraphs to maintain continuity of data and enable advanced querying and analysis. Additionally, or alternatively, storing the one or more additional subgraphs may facilitate the identification of patterns, relationships, and/or trends that may arise from multiple transactions over time. The storage may occur in real-time and/or asynchronously, depending on the operational requirements of the digital ledger network.

In some embodiments, and as shown in block 1006, the process flow 1000 may include the step of linking one or more indexes of a plurality of indexes to the one or more additional subgraphs. In such embodiment, the linked indexes may be dynamically updated to reflect the attributes and/or relationships identified in the one or more additional subgraphs. Additionally, or alternatively, linking the one or more indexes to the one or more additional subgraphs may enhance the querying and retrieval of transaction data by facilitating faster lookup and analysis of shared attributes between multiple transactions. Further, the linkage may be configured to support bidirectional references between the indexes and the additional subgraphs, enabling efficient data traversal and indexing for future transactions.

The process flow 1000 may include additional embodiments, such as any single embodiment or any combination of embodiments described herein. Although FIG. 10 shows example blocks of the process flow 1000, in some embodiments, the process flow 1000 may include additional blocks, fewer blocks, different blocks, or differently arranged blocks than those depicted in FIG. 10.

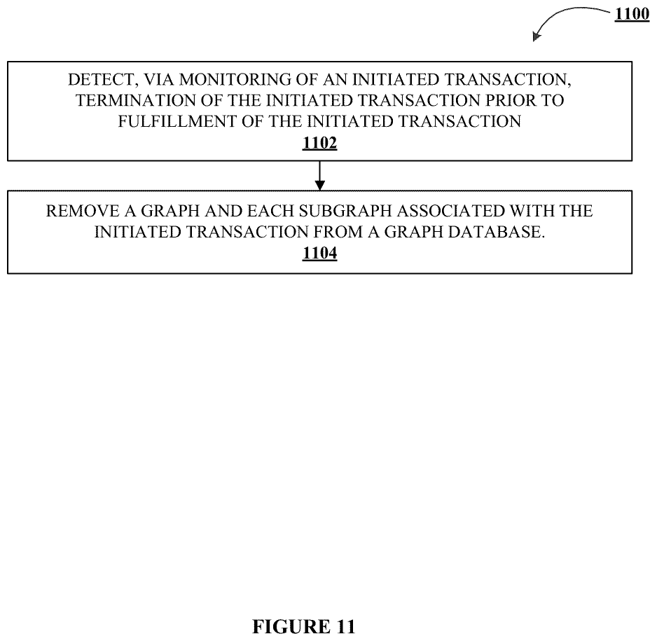

FIG. 11 illustrates another process flow 1100 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 1100. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 1100. In some embodiments, an artificial intelligence engine (e.g., similar to the AI engine subsystem 200 as shown and described herein with respect to FIG. 2) may perform one or more of the steps of process flow 1100. Additionally, or alternatively, a generative artificial intelligence engine (e.g., similar to the generative AI subsystem 300 as shown and described herein with respect to FIG. 3) may perform one or more of the steps of process flow 1100. In some embodiments, a digital ledger network (e.g., similar to the distributed ledger 404 as shown and described herein with respect to FIG. 4) may be configured to perform, assist in, store data in, and/or the like one or more steps of process flow 1100.

In some embodiments, and as shown in block 1102, the process flow 1100 may include the step of detecting, via monitoring of an initiated transaction, termination of the initiated transaction prior to fulfillment of the initiated transaction. In such embodiments, the termination may be detected by analyzing transaction status updates, timeouts, error signals, and/or the like received from the digital ledger network. Additionally, or alternatively, detecting the termination may involve evaluating conditions associated with the transaction lifecycle to identify scenarios where the initiated transaction has been canceled, timed out, and/or otherwise failed prior to completion.

In some embodiments, and as shown in block 1104, the process flow 1100 may include the step of removing a graph and each subgraph associated with the initiated transaction from a graph database. In such embodiments, the removal may be performed to prevent the retention of unnecessary data and/or to maintain data consistency within the graph database. Additionally, or alternatively, removing the graph and each subgraph may involve identifying and deleting any indexes, references, and/or linked attributes associated with the terminated initiated transaction to ensure complete data cleanup. In some embodiments, termination of a transaction may not engender removal of graphs and subgraphs associated with the transaction in cases where meaningful data for future transactions may be found (e.g., transactions terminated due to threat determinations).

The process flow 1100 may include additional embodiments, such as any single embodiment or any combination of embodiments described herein. Although FIG. 11 shows example blocks of the process flow 1100, in some embodiments, the process flow 1100 may include additional blocks, fewer blocks, different blocks, or differently arranged blocks than those depicted in FIG. 11.

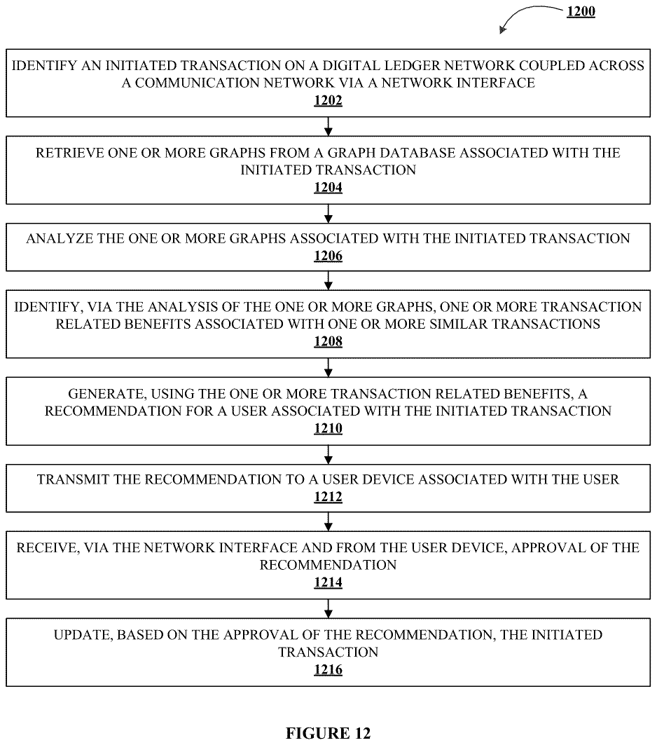

FIG. 12 illustrates another process flow 1200 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 1200. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 1200. In some embodiments, an artificial intelligence engine (e.g., similar to the AI engine subsystem 200 as shown and described herein with respect to FIG. 2) may perform one or more of the steps of process flow 1200. Additionally, or alternatively, a generative artificial intelligence engine (e.g., similar to the generative AI subsystem 300 as shown and described herein with respect to FIG. 3) may perform one or more of the steps of process flow 1200. In some embodiments, a digital ledger network (e.g., similar to the distributed ledger 404 as shown and described herein with respect to FIG. 4) may be configured to perform, assist in, store data in, and/or the like one or more steps of process flow 1200.

In some embodiments, and as shown in block 1202, the process flow 1200 may include the step of identifying an initiated transaction on a digital ledger network coupled across a communication network via a network interface. In such embodiments, the digital ledger network (e.g., similar to the digital ledger network 502 as shown and described herein with respect to FIG. 5) may include multiple entities that interact within the ecosystem, such as resource-exchange device providers, users, offering third parties, and/or the like. The initiated transaction may be detected via an event listener (e.g., similar to the event listener 504 as shown and described herein with respect to FIG. 5) configured to capture signals or messages indicative of transaction initiation. Upon identification, the system may proceed to retrieve one or more graphs associated with the initiated transaction for further analysis.

In some embodiments, and as shown in block 1204, the process flow 1200 may include the step of retrieving one or more graphs from a graph database associated with the initiated transaction. In such embodiments, the graph database (e.g., similar to the graph database 510 as shown and described herein with respect to FIG. 5) may store multiple graphs, where each graph may represent a transaction pattern, attribute set, and/or relationship between entities involved in similar transactions. The retrieval process may include querying the graph database using attributes of the initiated transaction to identify matching or related graphs. Additionally, or alternatively, the retrieval may involve accessing indexed records that link graph data to the initiated transaction, enabling efficient extraction of relevant graph information. In some embodiments, the graph database may be a transaction history repository stored within the digital ledger network.

In some embodiments, and as shown in block 1206, the process flow 1200 may include the step of analyzing the one or more graphs associated with the initiated transaction. In such embodiments, the analysis may include evaluating graph structures, node connections, and edge relationships to identify patterns or anomalies within the graph data. Additionally, or alternatively, the analysis may apply AI techniques to detect correlations between the initiated transaction and previous transactions that exhibit similar graph structures. The analysis may further identify key attributes, such as transaction amounts, participating entities, timing of the transactions, associated resources, associated products, resource-exchange devices, and/or the like that may be leveraged in subsequent steps of the process.

In some embodiments, and as shown in block 1208, the process flow 1200 may include the step of identifying, via the analysis of the one or more graphs, one or more transaction-related benefits associated with one or more similar transactions. In such embodiments, the one or more transaction-related benefits may be derived from historical data of previous transactions exhibiting similar attributes to the initiated transaction. Additionally, or alternatively, identifying the one or more transaction-related benefits may include querying a benefits database linked to the graph database to search for associated offers and/or other relevant advantages that align with the attributes of the initiated transaction. Additionally, or alternatively, a subset of the digital ledger network may be queried to search for associated offers and/or other relevant advantages that align with the attributes of the initiated transaction. The identification may further incorporate AI models, including a benefits suggester (e.g., similar to the benefits suggester 520 as shown and described herein with respect to FIG. 5), that may be configured as a black-box model to search for benefits based on input graph data.

In some embodiments, and as shown in block 1210, the process flow 1200 may include the step of generating, using the one or more transaction-related benefits, a recommendation for a user associated with the initiated transaction. In such embodiments, the recommendation may be generated by analyzing the identified transaction-related benefits and selecting the most relevant and/or advantageous benefits for the user. Additionally, or alternatively, generating the recommendation may include utilizing an intelligent recommendation engine powered by AI models, including the benefits suggester, to determine what benefits align most closely with the user's historical preferences, transaction patterns, best use of resources of the user, and/or the like. Further, the generated recommendation may include detailed information about the identified benefits, such as potential cost savings and/or enhanced transaction outcomes, which may be presented to the user for review and approval.

In some embodiments, and as shown in block 1212, the process flow 1200 may include the step of transmitting the recommendation to a user device associated with the user. In such embodiments, the transmission may occur via the network interface to ensure secure and timely delivery of the recommendation to the user device. Further, the transmitted recommendation may be presented to the user through an application interface, a web portal, and/or another suitable communication channel. Additionally, or alternatively, the recommendation may include actionable options that the user may select to proceed with the suggested benefits or modify the initiated transaction based on the received insights.

In some embodiments, and as shown in block 1214, the process flow 1200 may include the step of receiving, via a network interface and from the user device, approval of the recommendation. In such embodiments, the approval may be captured through a user interaction, such as selecting a confirmation option within an application interface or web portal. The approval may also include user authentication and/or validation to ensure that the response is authorized. Additionally, or alternatively, the approval may be accompanied by user modifications to the initiated transaction or updates to transaction-related parameters, which the system may process before proceeding to update the initiated transaction.

In some embodiments, and as shown in block 1216, the process flow 1200 may include the step of updating, based on the approval of the recommendation, the initiated transaction. In some embodiments, the updating may include modifying transaction attributes, adjusting transaction parameters, and/or appending metadata related to the approved recommendation. Further, the system may dynamically apply the updates to the initiated transaction in real time, ensuring that the updates align with the approved recommendation and maintain consistency with previously stored transaction records. Additionally, or alternatively, the update may trigger the generation of an updated graph and/or subgraph that reflects the modified state of the initiated transaction, that may be stored in the graph database for future reference and analysis.

The process flow 1200 may include additional embodiments, such as any single embodiment or any combination of embodiments described herein. Although FIG. 12 shows example blocks of the process flow 1200, in some embodiments, the process flow 1200 may include additional blocks, fewer blocks, different blocks, or differently arranged blocks than those depicted in FIG. 12.

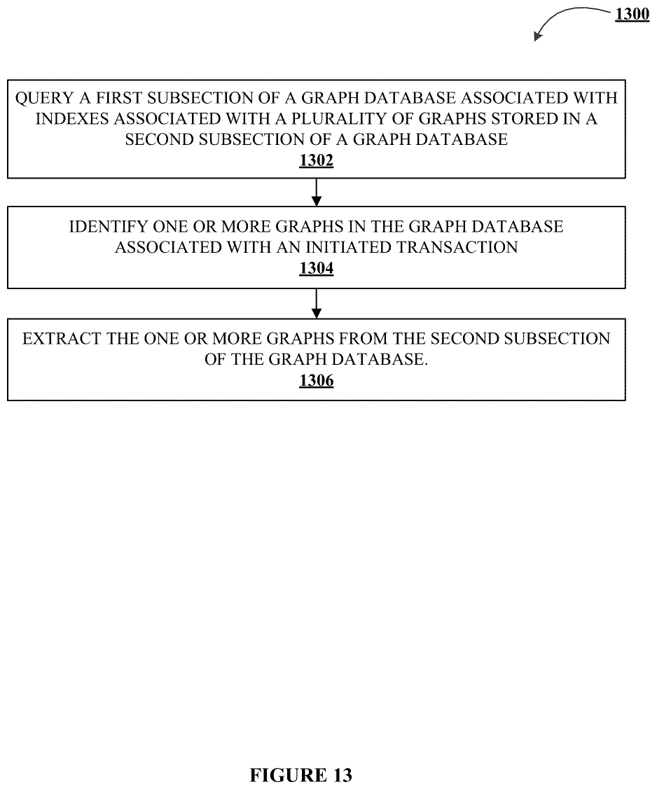

FIG. 13 illustrates another process flow 1300 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 1300. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 1300. In some embodiments, an artificial intelligence engine (e.g., similar to the AI engine subsystem 200 as shown and described herein with respect to FIG. 2) may perform one or more of the steps of process flow 1300. Additionally, or alternatively, a generative artificial intelligence engine (e.g., similar to the generative AI subsystem 300 as shown and described herein with respect to FIG. 3) may perform one or more of the steps of process flow 1300. In some embodiments, a digital ledger network (e.g., similar to the distributed ledger 404 as shown and described herein with respect to FIG. 4) may be configured to perform, assist in, store data in, and/or the like one or more steps of process flow 1300.

In some embodiments, and as shown in block 1302, the process flow 1300 may include the step of querying a first subsection of a graph database associated with indexes associated with a plurality of graphs stored in a second subsection of the graph database. In such embodiments, the query may include searching for indexes linked to one or more graphs that correspond to attributes of an initiated transaction. The first subsection may store indexes that maintain references to graph structures and facilitate efficient retrieval of relevant graphs. Additionally, or alternatively, the query may include applying one or more search parameters that narrow the search scope by matching transaction-related attributes, such as entity information, transaction types, and/or historical patterns. In some embodiments, the step of block 1302 of the process flow 1300 may be performed in conjunction with and/or following the step of block 1204 of the process flow 1200 as shown and described herein with respect to FIG. 12.

In some embodiments, and as shown in block 1304, the process flow 1300 may include the step of identifying one or more graphs in the graph database associated with the initiated transaction. In such embodiments, the identification may be based on the results of the query executed in the step of block 1302, where the identified graphs may exhibit one or more shared attributes with the initiated transaction. Further, the system may apply graph-matching algorithms and/or similarity metrics to determine the relevance of the identified graphs. Additionally, or alternatively, the identified graphs may be selected based on a threshold similarity score, ensuring that only the most relevant graphs are retrieved for further analysis.

In some embodiments, and as shown in block 1306, the process flow 1300 may include the step of extracting the one or more graphs from the second subsection of the graph database. In such embodiments, the extraction process may include retrieving graph data stored in a structured format, where each graph may be associated with an index maintained in the first subsection of the graph database. Further, the extracted graphs may be formatted into a suitable structure for further analysis and processing. Additionally, or alternatively, the extraction process may involve performing a consistency check to ensure that the extracted graphs align with the attributes of the initiated transaction, reducing the likelihood of errors in subsequent processing.

The process flow 1300 may include additional embodiments, such as any single embodiment or any combination of embodiments described herein. Although FIG. 13 shows example blocks of the process flow 1300, in some embodiments, the process flow 1300 may include additional blocks, fewer blocks, different blocks, or differently arranged blocks than those depicted in FIG. 13.

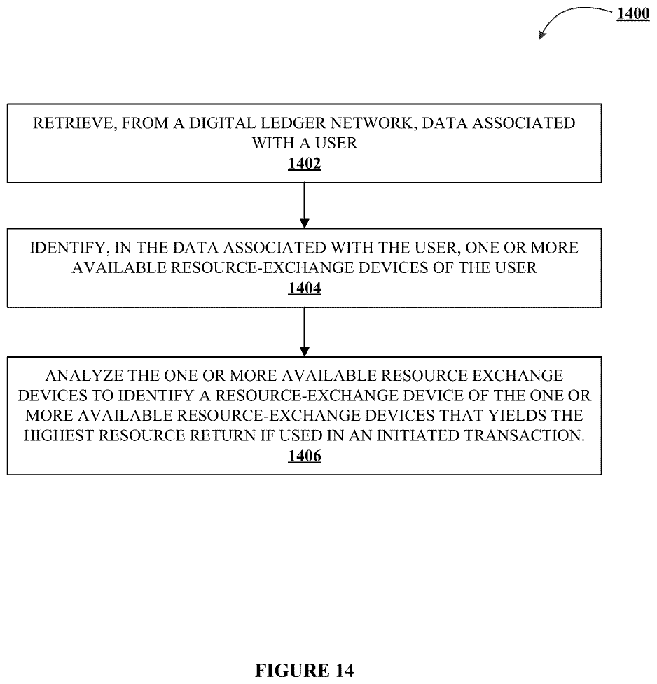

FIG. 14 illustrates another process flow 1400 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 1400. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 1400. In some embodiments, an artificial intelligence engine (e.g., similar to the AI engine subsystem 200 as shown and described herein with respect to FIG. 2) may perform one or more of the steps of process flow 1400. Additionally, or alternatively, a generative artificial intelligence engine (e.g., similar to the generative AI subsystem 300 as shown and described herein with respect to FIG. 3) may perform one or more of the steps of process flow 1400. In some embodiments, a digital ledger network (e.g., similar to the distributed ledger 404 as shown and described herein with respect to FIG. 4) may be configured to perform, assist in, store data in, and/or the like one or more steps of process flow 1400.

In some embodiments, and as shown in block 1402, the process flow 1400 may include the step of retrieving, from a digital ledger network, data associated with a user. In such embodiments, the data associated with the user may include historical transaction data, resource-exchange device usage patterns, owned resource-exchange devices, preferences related to resource-exchange device selection, and/or the like. Further, the retrieval process may utilize secure communication protocols to ensure that sensitive data remains protected during the data transfer. Additionally, or alternatively, the retrieval process may include querying the digital ledger network using a unique identifier associated with the user to obtain relevant data efficiently. In some embodiments, the step of block 1402 of the process flow 1400 may be performed in conjunction with and/or following the step of block 1208 of the process flow 1200 as shown and described herein with respect to FIG. 12.

In some embodiments, and as shown in block 1404, the process flow 1400 may include the step of identifying, in the data associated with the user, one or more available resource-exchange devices of the user. In such embodiments, the identification process may involve parsing through retrieved data to detect active and valid resource-exchange devices linked to the user. Further, each available resource-exchange device may be evaluated based on its current status, associated limits, usage benefits, and/or past usage patterns. Additionally, or alternatively, the identification process may apply filtering rules to exclude expired, inactive, or restricted resource-exchange devices from further analysis.

In some embodiments, and as shown in block 1406, the process flow 1400 may include the step of analyzing the one or more available resource-exchange devices to identify a resource-exchange device of the one or more available resource-exchange devices that yields the highest resource return if used in the initiated transaction. In such embodiments, the analysis may include comparing the performance, transaction resource costs, resource limits, usage benefits, conditional usage benefits, or other relevant metrics associated with each resource-exchange device. Further, the system may use predictive algorithms, historical transaction data, and other parameters to assess which device provides the most beneficial resource return for the initiated transaction. In some embodiments, the system may rank the available resource-exchange devices based on their potential return, allowing the system to select the optimal device for the transaction.

The process flow 1400 may include additional embodiments, such as any single embodiment or any combination of embodiments described herein. Although FIG. 14 shows example blocks of the process flow 1400, in some embodiments, the process flow 1400 may include additional blocks, fewer blocks, different blocks, or differently arranged blocks than those depicted in FIG. 14.

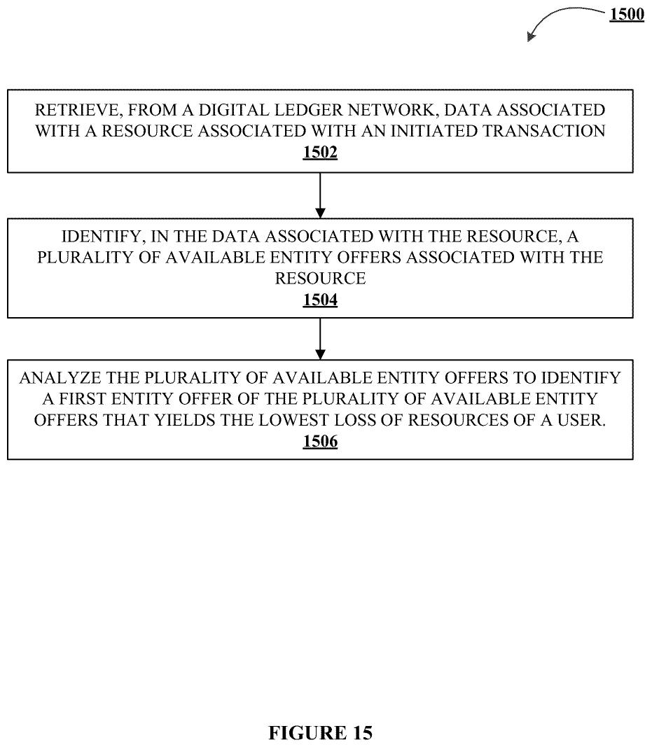

FIG. 15 illustrates another process flow 1500 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 1500. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 1500. In some embodiments, an artificial intelligence engine (e.g., similar to the AI engine subsystem 200 as shown and described herein with respect to FIG. 2) may perform one or more of the steps of process flow 1500. Additionally, or alternatively, a generative artificial intelligence engine (e.g., similar to the generative AI subsystem 300 as shown and described herein with respect to FIG. 3) may perform one or more of the steps of process flow 1500. In some embodiments, a digital ledger network (e.g., similar to the distributed ledger 404 as shown and described herein with respect to FIG. 4) may be configured to perform, assist in, store data in, and/or the like one or more steps of process flow 1500.

In some embodiments, and as shown in block 1502, the process flow 1500 may include the step of retrieving, from a digital ledger network, data associated with a resource associated with an initiated transaction. In such embodiments, the digital ledger network may include a distributed system where transactional data related to various resources may be stored, maintained, and/or validated by multiple nodes. Further, the data associated with the resource may include historical usage information, associated entity offers, applicable terms and conditions, and/or relevant attributes of the resource. Additionally, or alternatively, the retrieval process may be initiated in response to a trigger from an event listener monitoring the progress of the initiated transaction, ensuring timely data acquisition for subsequent analysis. In some embodiments, the step of block 1502 of the process flow 1500 may be performed in conjunction with and/or following the step of block 1208 of the process flow 1200 as shown and described herein with respect to FIG. 12.

In some embodiments, and as shown in block 1504, the process flow 1500 may include the step of identifying, in the data associated with the resource, a plurality of available entity offers associated with the resource. In such embodiments, the plurality of available entity offers may be retrieved by querying relevant sections of the data to locate offers from multiple entities that provide resources and/or services relevant to the initiated transaction. Additionally, or alternatively, the identification process may include analyzing offer parameters (e.g., associated costs, applicable discounts, time constraints, and/or user-specific preferences). Further, the identification process may leverage models (e.g., various types of AI models) trained on historical transaction data to identify offers most relevant to the current transaction context.

In some embodiments, and as shown in block 1506, the process flow 1500 may include the step of analyzing the plurality of available entity offers to identify a first entity offer of the plurality of available entity offers that yields the lowest loss of resources of the user. In such embodiments, the analysis may include evaluating offer parameters, including but not limited to, additional transaction resource costs, resource conversion rates, and/or potential benefits linked to each entity offer. Further, the system may utilize an AI-based engine (e.g., similar to the benefits suggester 520 as shown and described herein with respect to FIG. 5) to assess the long-term impact of selecting each entity offer and to identify the offer that minimizes the resource loss for the user. Additionally, or alternatively, historical transaction data may be analyzed to identify trends and patterns that indicate optimal entity offers for minimizing resource loss in similar contexts. Based on the analysis performed, the first entity offer may be identified as the preferred entity offer for the user to minimize a loss of resources for the user.

In some embodiments, a second entity offer of the plurality of available entity offers may be identified that includes an offer for the user to transfer a higher amount of resources than the first entity offer upon completion of the initiated transaction, but the user may receive a portion of the resources they transferred to complete the transaction back at a later date upon meeting one or more requirements (e.g., transferring a completed and signed document) such that the net resources lost by the user at the later date may be less than the resources lost by the user by accepting the first entity offer. In such embodiments, the user may receive a plurality of options including the first entity offer and the second entity offer in a recommendation on how to proceed with the initiated transaction.

The process flow 1500 may include additional embodiments, such as any single embodiment or any combination of embodiments described herein. Although FIG. 15 shows example blocks of the process flow 1500, in some embodiments, the process flow 1500 may include additional blocks, fewer blocks, different blocks, or differently arranged blocks than those depicted in FIG. 15.

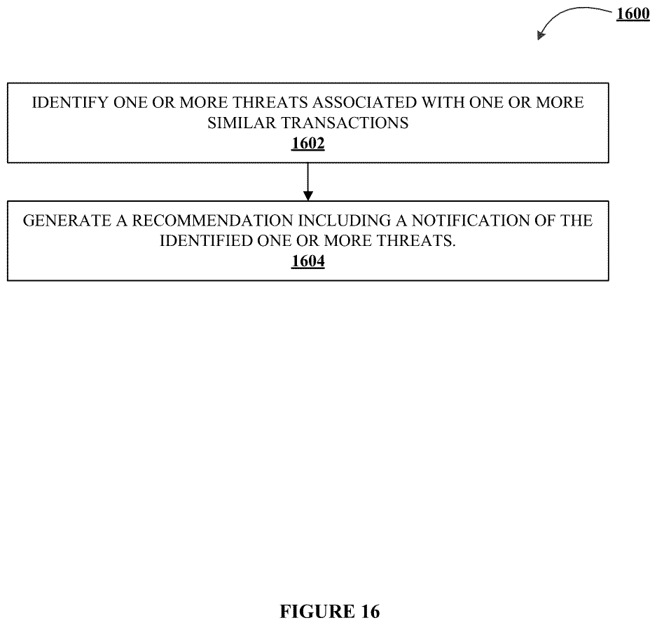

FIG. 16 illustrates another process flow 1600 for intelligent graph data triggers and/or an intelligent routing engine for an opt-in collaborative digital ledger network, in accordance with an embodiment of the invention. In some embodiments, a system (e.g., similar to one or more of the systems shown and described herein with respect to FIGS. 1A-1C) may perform one or more of the steps of process flow 1600. For example, a system for intelligent graph data triggers and/or an intelligent routing engine for an opt-in collaborative digital ledger network (e.g., similar to the system 130 shown and described herein with respect to FIG. 1A-1C) may perform one or more of the steps of process flow 1600. In some embodiments, an artificial intelligence engine (e.g., similar to the AI engine subsystem 200 as shown and described herein with respect to FIG. 2) may perform one or more of the steps of process flow 1600. Additionally, or alternatively, a generative artificial intelligence engine (e.g., similar to the generative AI subsystem 300 as shown and described herein with respect to FIG. 3) may perform one or more of the steps of process flow 1600. In some embodiments, a digital ledger network (e.g., similar to the distributed ledger 404 as shown and described herein with respect to FIG. 4) may be configured to perform, assist in, store data in, and/or the like one or more steps of process flow 1600.

In some embodiments, and as shown in block 1602, the process flow 1600 may include the step of identifying one or more threats associated with one or more similar transactions. In such embodiments, the identification may include analyzing historical transaction data of the one or more similar transactions to detect patterns indicative of threatening activity, anomalous behavior, and/or inconsistencies suggesting potential threats. Further, AI models may be used (e.g., similar to the benefits suggester 520 as shown and described herein with respect to FIG. 5) to assess threat factors associated with the one or more similar transactions. Additionally, or alternatively, a weighted scoring model may be applied that evaluates multiple attributes of the similar transactions, such as transaction amount, entity reputation, and/or frequency of transaction type, to identify potential threats. In some embodiments, the step of block 1602 of the process flow 1600 may be performed in conjunction with and/or following the step of block 1206 of the process flow 1200 as shown and described herein with respect to FIG. 12.

In some embodiments, and as shown in block 1604, the process flow 1600 may include the step of generating a recommendation including a notification of the identified one or more threats. In such embodiments, the recommendation may be generated based on the threat analysis results with the notification being customized to provide detailed information regarding the identified threats. Further, the generated notification may include information on the nature of the threats, the potential impact on the initiated transaction, and/or a suggested course of action to mitigate the threats. Additionally, or alternatively, the recommendation may incorporate insights derived from historical patterns of successful threat mitigation and suggest preventative measures to avoid similar threats in the future. In some embodiments, the generated notification may be formatted for transmission to a user device, allowing the user to take informed action regarding the initiated transaction.

The process flow 1600 may include additional embodiments, such as any single embodiment or any combination of embodiments described herein. Although FIG. 16 shows example blocks of the process flow 1600, in some embodiments, the process flow 1600 may include additional blocks, fewer blocks, different blocks, or differently arranged blocks than those depicted in FIG. 16.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in party to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for an intelligent routing engine for an opt-in collaborative digital ledger network, the system comprising:
a network interface configured to communicate via a communication network;
at least one non-transitory storage device comprising computer program code stored thereon; and
at least one processing device operably coupled to the network interface, and the at least one non-transitory storage device, wherein the computer program code comprises computer instructions configured to cause the processing device to:
identify, via an event listener, an initiated transaction on a digital ledger network coupled across the communication network via the network interface;
retrieve, from the digital ledger network, data associated with a user associated with the initiated transaction;
identify, in the data associated with the user, one or more available resource-exchange devices of the user;
retrieve one or more graphs from a graph database associated with the initiated transaction;
analyze the one or more graphs associated with the initiated transaction;
analyze the one or more available resource-exchange devices to identify a resource-exchange device of the one or more available resource-exchange devices that yields the highest resource return if used in the initiated transaction;
identify, via the analysis of the one or more graphs, one or more transaction related benefits associated with one or more similar transactions;
generate, using the one or more transaction related benefits, the identified resource-exchange device, and a benefits suggester comprising one or more artificial intelligence models, a recommendation for the user
transmit the recommendation to a user device associated with the user;
receive, via the network interface and from the user device, approval of the recommendation; and
update, based on the approval of the recommendation, the initiated transaction.

2. The system of claim 1, wherein the at least one non-transitory storage device comprises computer-executable program code that, when executed by the at least one processing device, causes the at least one processing device to, when retrieving the one or more graphs:
query a first subsection of the graph database associated with indexes associated with a plurality of graphs stored in a second subsection of the graph database;
identify the one or more graphs in the graph database associated with the initiated transaction; and
extract the one or more graphs from the second subsection of the graph database.

3. (canceled)

4. The system of claim 1, wherein the at least one non-transitory storage device comprises computer-executable program code that, when executed by the at least one processing device, causes the at least one processing device to, when identifying the one or more transaction related benefits:
retrieve, from the digital ledger network, data associated with a resource associated with the initiated transaction;
identify, in the data associated with the resource, a plurality of available entity offers associated with the resource; and
analyze the plurality of available entity offers to identify a first entity offer of the plurality of available entity offers that yields the lowest loss of resources of the user.

5. The system of claim 4, wherein the recommendation for the user comprises the first entity offer and the identified resource exchange device.

6. The system of claim 4, wherein a second entity offer of the plurality of available entity offers comprises an offer for the user to transfer a higher amount of resources than the first entity offer upon completion of the initiated transaction and to receive a portion of the transferred higher amount of resources back at a later date upon meeting one or more requirements, and wherein the recommendation to the user comprises a plurality of options comprising the first entity offer and the second entity offer.

7. The system of claim 1, wherein the at least one non-transitory storage device comprises computer-executable program code that, when executed by the at least one processing device, causes the at least one processing device to, when analyzing the one or more graphs:
identify one or more threats associated with the one or more similar transactions; and
generate the recommendation comprising a notification of the identified one or more threats.

8. The system of claim 1, wherein data associated with the initiated transaction is stored as a graph and one or more subgraphs of the graph in the graph database.

9. A computer program product for an intelligent routing engine for an opt-in collaborative digital ledger network, the computer program product comprising a non-transitory computer-readable medium comprising code causing an apparatus to:
identify, via an event listener, an initiated transaction on a digital ledger network coupled across a communication network via a network interface;
retrieve, from the digital ledger network, data associated with a user associated with the initiated transaction;
identify, in the data associated with the user, one or more available resource-exchange devices of the user;
retrieve one or more graphs from a graph database associated with the initiated transaction;
analyze the one or more graphs associated with the initiated transaction;
analyze the one or more available resource-exchange devices to identify a resource-exchange device of the one or more available resource-exchange devices that yields the highest resource return if used in the initiated transaction;
identify, via the analysis of the one or more graphs, one or more transaction related benefits associated with one or more similar transactions;
generate, using the one or more transaction related benefits, the identified resource-exchange device, and a benefits suggester comprising one or more artificial intelligence models, a recommendation for the user;
transmit the recommendation to a user device associated with the user;
receive, via the network interface and from the user device, approval of the recommendation; and
update, based on the approval of the recommendation, the initiated transaction.

10. The computer program product of claim 9, wherein the non-transitory computer-readable medium comprises code causing an apparatus to, when retrieving the one or more graphs:
query a first subsection of the graph database associated with indexes associated with a plurality of graphs stored in a second subsection of the graph database;
identify the one or more graphs in the graph database associated with the initiated transaction; and
extract the one or more graphs from the second subsection of the graph database.

11. (canceled)

12. The computer program product of claim 9, wherein the non-transitory computer-readable medium comprises code causing an apparatus to, when identifying the one or more transaction related benefits:
retrieve, from the digital ledger network, data associated with a resource associated with the initiated transaction;
identify, in the data associated with the resource, a plurality of available entity offers associated with the resource; and
analyze the plurality of available entity offers to identify a first entity offer of the plurality of available entity offers that yields the lowest loss of resources of the user.

13. The computer program product of claim 12, wherein the recommendation for the user comprises the first entity offer and the identified resource exchange device.

14. The computer program product of claim 12, wherein a second entity offer of the plurality of available entity offers comprises an offer for the user to transfer a higher amount of resources than the first entity offer upon completion of the initiated transaction and to receive a portion of the transferred higher amount of resources back at a later date upon meeting one or more requirements, and wherein the recommendation to the user comprises a plurality of options comprising the first entity offer and the second entity offer.

15. The computer program of claim 9, wherein the non-transitory computer-readable medium comprises code causing an apparatus to, when analyzing the one or more graphs:
identify one or more threats associated with the one or more similar transactions; and
generate the recommendation comprising a notification of the identified one or more threats.

16. The computer program product of claim 9, wherein data associated with the initiated transaction is stored as a graph and one or more subgraphs of the graph in the graph database.

17. A computer-implemented method for an intelligent routing engine for an opt-in collaborative digital ledger network, the method comprising:
identifying, via an event listener, an initiated transaction on a digital ledger network coupled across a communication network a the network interface;
retrieving, from the digital ledger network, data associated with a user associated with the initiated transaction;
identifying, in the data associated with the user, one or more available resource-exchange devices of the user;
retrieving one or more graphs from a graph database associated with the initiated transaction;
analyzing the one or more graphs associated with the initiated transaction;
analyzing the one or more available resource-exchange devices to identify a resource-exchange device of the one or more available resource-exchange devices that yields the highest resource return if used in the initiated transaction;
identifying, via the analysis of the one or more graphs, one or more transaction related benefits associated with one or more similar transactions;
generating, using the one or more transaction related benefits, the identified resource-exchange device, and a benefits suggester comprising one or more artificial intelligence models, a recommendation for the user;
transmitting the recommendation to a user device associated with the user;
receiving, via the network interface and from the user device, approval of the recommendation; and
updating, based on the approval of the recommendation, the initiated transaction.

18. The method of claim 17, the method further comprising, when retrieving the one or more graphs:
querying a first subsection of the graph database associated with indexes associated with a plurality of graphs stored in a second subsection of the graph database;
identifying the one or more graphs in the graph database associated with the initiated transaction; and
extracting the one or more graphs from the second subsection of the graph database.

19. (canceled)

20. The method of claim 17, the method further comprising, when identifying the one or more transaction related benefits:
retrieving, from the digital ledger network, data associated with a resource associated with the initiated transaction;
identifying, in the data associated with the resource, a plurality of available entity offers associated with the resource; and
analyzing the plurality of available entity offers to identify a first entity offer of the plurality of available entity offers that yields the lowest loss of resources of the user.

21. The system of claim 1, wherein the at least one non-transitory storage device comprises computer-executable program code that, when executed by the at least one processing device, causes the at least one processing device to, after updating the initiated transaction, generate, via a graph index framer and a large language model, a graph index for the updated transaction.
